(19) United States
(12) Patent Application Publication
(10) Pub. No.: US 2006/0265344 A1
(43) Pub. Date: Nov. 23, 2006

(54) System, Method, and Computer Program Product for Internet Tool

(76) Inventor: Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 10/908,645

(22) Filed: May 20, 2005

(51) Int. Cl. G06F 17/30; G06F 7/00

(52) U.S. Cl. 707/1

(57) ABSTRACT

A method, apparatus and computer program product for an interface for receiving a user input and a user selection signal and for concurrently supporting a set of service templates; and a specification compiling system communicable to a network supporting the network resource for combining the user input with a user-specified service template selected from the set of service templates responsive to the user selection signal to produce the resource access specification.

### CROSS REFERENCE TO RELATED APPLICATIONS

This application is related to U.S. patent application Ser. No. 10/994,896 filed 22 Nov. 2004 and entitled “SYSTEM, METHOD AND COMPUTER PROGRAM PRODUCT FOR INTERNET TOOL” and related to U.S. patent application Ser. No. 10/995,044 filed 22 Nov. 2004 and entitled “SYSTEM, METHOD AND COMPUTER PROGRAM PRODUCT FOR INTERNET TOOL,” and related to U.S. patent application Ser. No. 10/908,264 filed 4 May 2005 and entitled “SYSTEM, METHOD AND COMPUTER PROGRAM PRODUCT FOR INTERNET TOOL,” the disclosures of which are expressly incorporated by reference in their entireties for all purposes.

### BACKGROUND OF THE INVENTION

The present invention relates generally to resource navigation and more specifically to navigation to and retrieval of resources located on local or networked locations of an electronic device.

It is well-known to provide network access applications (e.g., Internet browsers) to search, navigate, and access network resources. These applications typically require a user to enter a resource identifier (e.g., a universal resource locator or URL, a resource identified by name—universal naming convention (UNC) or directory/file system (DFS)).

These resources may be distributed widely across many locations, both local and remote, requiring the user to enter many diverse resource identifiers to identify and retrieve all the desired resources. Often these identifiers have long names and in many cases, machine-generated names that challenge an ability of most users to remember them. There are solutions that aid the user in remembering or discovering these names: such as for example bookmarks used with browsers and search engines.

Many network access applications provide the user with an ability to store a desired identifier into a drop down list. Whenever the user wants to access a resource for which the user has stored the identifier, the user selects the stored identifier from a list. This is easy, provided that the user recognizes the resource from the stored identifier, and provided that the list of stored identifiers is not unduly long. Some access applications assist in management of stored identifiers by providing yet another directory/subdirectory structure that helps some users locate the particular identifier but which creates another layer of complexity.

There are many search engines, some general purpose and some special purpose, that users may use to locate particular resources. Due to the large amount of available resources, and great diversity of search engines there are instances in which a resource, or the associated link to the resource, is fungible. A user looking for the content of a link and not specifically for a certain link is able to use the search engine solution and does not necessarily need to remember any single identifier or any particular access paradigm. For example, a user desiring to locate a resource providing a proper spelling of a word has available many different resources that could provide acceptable answers. Over time, users develop preferred lists and collections of resources to aid in their common queries.

One common resource type that is bookmarked by many users are local search functions. The identifier provides a resource that permits the user to enter desired parameters, initiate the search with the specified parameters, and obtain the results of the search. Many Internet search engines, that is, a search engine for multiple public domains, provide this search function to identify specific words on any of the multitudes of available web pages. Google Inc. (www.google.com) and Yahoo Inc. (www.yahoo.com) are two representative companies that provide this type of Internet search engine. A user may navigate to the appropriate site and use the provided on-site search tools or use a provided toolbar associated with a web browser and the site that includes a text input feature to enable a user to directly access predetermined search engine features using information provided in the text input control. Due to the general nature and scope of the search engines and the typical simplicity of the text in the input control, the search engine returns countless pages of candidate identifiers, any one of which could be the desired identifier. Many times it is like looking for the proverbial needle in a haystack. Different users have different skill in managing and operating search engines resulting in different lists of candidate identifiers. Search engines, particularly those that include features that generate revenue from search terms or from association of advertisements with particular search terms may have a perceived conflict of interest of sorts in efficiently presenting narrow results of search terms.

Because many searches are tiered, that is a user uses a general search engine to find a specific search engine to use for finding a specific result, variations in search engine operation skills cumulatively contribute to a very wide variation in effectiveness for resource retrieval across a group of users. It is difficult if not impossible for strengths of some users for locating and using search engines to directly benefit other users.

To assist users with their searches using a specific site, many of the search engines provide the user with a dedicated search toolbar for accessing the search engine. These toolbars typically have a data entry field for a search query, and an actuable button to access the designated search engine with the contents of the data entry field. The toolbar gives the user access to the specific toolbar associated search engine anytime that the toolbar is active, typically when the associated application is active. Some toolbars permit the user to associate the text input with a different sub-search from the same domain. In general, the toolbar provider controls the content of the toolbar and often limits the toolbar to use with a specific search engine, sometimes providing a user with an ability to customize the toolbar with features from the associated website.

To access multiple search systems, the prior art provides two solutions. One is to add multiple toolbars, one for each search system. The second is to provide a drop down list that reconfigures a particular association between the data entry field and one of a group of predefined search engines. One such product is Ultrabar® available from www.ultrabar.com (Ultrabar being a wholly owned subsidiary of VPOP Technologies, Inc., (www.vpop.net)).

This toolbar provides drop-down configuration to associate a particular search function with the single data entry field. In one configuration, the user selects a first search engine using a drop-down list of configured search engines. When the user actuates a different search initiation button, content of a data entry field is sent to the first search engine. When a second engine is selected from the drop down list, a search of the second engine is initiated with the content of the data entry field. In this way, functionality of several search-toolbars are added to a single toolbar, but the operation of the toolbar is the same after each configuration. Namely, actuation of the search initiation button submits the information into the designated search engine. Some of these toolbars provide the user with an ability to add custom search engines/locations to the toolbar.

Unfortunately, these solutions are cumbersome for efficiently accessing a range of information. When multiple sites are searched for different types of information, a user is continuously changing search engines. When there are more than a few options, the dropdown lists may become crowded and cryptic, decreasing the efficiency. Many users do not have the training and/or inclination to produce customized search engine entries to add their own searches. Thus, a user is limited to options provided to the user at the time of the installation of the toolbar. Additionally, these configurations are typically only available for local computing systems, meaning a user may reconfigure each computing system using the same cryptic, often difficult identifier description system.

What is needed is an efficient toolbar solution that provides a user with simple and quick searches across a plurality of locations, and one that may be expanded without complicated or time-consuming configuration options, as well providing users with a solution to simple, uniform, and convenient implementation on multiple computing systems.

### BRIEF SUMMARY OF THE INVENTION

Disclosed is a method, apparatus and computer program product for an interface for receiving a user input and a user selection signal and for concurrently supporting a set of service templates; and a specification compiling system communicable to a network supporting the network resource for combining the user input with a user-specified service template selected from the set of service templates responsive to the user selection signal to produce the resource access specification.

This method is also implemented by executing program instructions included in a propagated signal or in a computer program product including a computer readable medium carrying the program instructions for accessing a resource when executed using a computing system. In some cases, a single control element actuates a heuristic analysis of a content of the data field and selects the appropriate queryable process from the available querys, taking any defined themes into account.

The present invention is an efficient and simple solution to improving a user's ability to quickly and accurately produce resource access directives to a desired one or more queryable network processes, such as for example, generating search queries for desired information. Queries are grouped in desired collections, a collection being a theme, permitting the user to access the network processes as reference sources for targeted specific results. Users do not have to remember search locations, or learn how to configure/maintain limited search engines. In some implementations, queries associated with themes may be updated, manually or automatically simply without learning or implementing a limited macroing language. Search skills and search methodologies may be easily shared and made available to a wide range of users.

### BRIEF DESCRIPTION OF THE DRAWINGS

FIG. 1 is a computer system that may function as a basic computer in implementing the present invention for an efficient interface solution that provides a user with simple and quick searches across a plurality of locations, and one that may be expanded without complicated or time-consuming configuration options;

FIG. 2 is an illustration of a graphical user interface for a preferred embodiment of the present invention as a stand-alone applet or process of a computer system;

FIG. 3 is an illustration of a toolbar implementation of an alternate preferred embodiment of the present invention;

FIG. 4 is a schematic view of a computer network, implementing a preferred embodiment of the present invention;

FIG. 5 is a schematic illustration of main components of a generic computer of the network shown in FIG. 4;

FIG. 6 is an illustration of a generic browser depicting a typical configuration;

FIG. 7 is a reconfigured web browser in which a query_input URL has been specified for the browser shown in FIG. 6;

FIG. 8 is a reconfigured web browser in which a Results_URL URL has been specified for the browser shown in FIG. 7;

FIG. 9 is a reconfigured web browser in which a preferred embodiment of the present invention for an interface control is included;

FIG. 10 is an illustration of the reconfigured web browser shown in FIG. 9 further depicting operation of a data input field, a theme selector control, and an engines control;

FIG. 11 is an illustration of a popup dialog control used as such an additional interface element to accommodate templates requesting multiple placeholder substitutions;

FIG. 12 is an illustration of a reconfigured web browser shown in FIG. 9 and FIG. 10 further depicting a specific example of heuristic service activation;

FIG. 13 is a schematic diagram of a network implementation of a preferred embodiment of the present invention for a theme-based resource retrieval system;

FIG. 14 is an illustration of a modified browser window depicting a theme selection window;

FIG. 15 is an illustration of a modified browser window 900 depicting a preferred theme creation/editing interface 1500;

FIG. 16 is an illustration of implementation of an alternate interface for a preferred embodiment of the present invention using an alternate computing system such as a portable electronic device including cellular phones, personal digital assistants (PDAs) and other wireless devices including browsing/resource access-retrieval capability; and

FIG. 17 is a representation of a webpage having a query input process.

### DETAILED DESCRIPTION OF THE INVENTION

The preferred embodiments of the present invention relate to an efficient navigation/retrieval interface, system, and method (e.g., a browser/application toolbar, independent process, and the like) solution that provides a user with simple and quick searches/retrievals across a plurality of locations, and one that may be expanded without complicated or time-consuming configuration options. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

Search engines have developed to provide users with an ability to locate resources distributed across many network machines, and now more recently, search engines include an ability to search local computing systems (e.g., Google Desktop Search, Yahoo Desktop Search, and MSN Desktop Search). There are general purpose search engines, as well as specialized search engines. General purpose search engines typically search and categorize resources across multiple domains and produce aggregated lists of resources with resource identifiers for accessing those lists using a particular protocol called HyperText Transport Protocol (HTTP). Specialized search engines perform similar services, though typically across a narrower candidate set of resources, often for a single domain. It is common for users to operate general purpose search engines to find resources that identify specialized search engines that ultimately produce a specific resource identifier. Accessing the resource using the resource identifier loads the resource into a process on the local computing system, typically in a browser, a browser plug-in specific to the resource type or a stand-alone application, process or function of the computing system.

By the nature of general purpose computing systems used for these tasks, including special programmed personal computers, workstations, servers, personal digital assistants (PDAs), cellular telephones, and other electronic devices and the like used in accessing resources via resource identifiers, have great versatility. This versatility contributes to the challenge in accessing specific, relevant resources amongst the multitudes of candidate resources and potential resources (some resources are dynamically generated so the different lists that may be generated are virtually limitless).

It is one fundamental concept of the preferred embodiments that, at any given time when a user is operating her workstation, she has a specific kind of task that she would like to accomplish. She may decide, for example, she wants to explore movies, or news, or investment opportunities. Like many people, she develops a set of search engines and search techniques over time, and favorite sites in mind for helping her with these tasks. New users are at a disadvantage because they do not have as much familiarity with search engines and search techniques so they may not be as proficient in locating and evaluating potential sites. For purposes of this patent application, a theme is defined as the cohesing concept behind a collection of search engines, search techniques, query input processes, and sites that are used for specific tasks. Any collection of engines, sites, processes, resources from these sites may be collected together into a theme.

When exploring investment opportunities (an investment exploration theme)—she may want to lookup a stock symbol, look up historical performance data, lookup current market price, maybe some favorite buy/sell recommendations from a couple of different advisors, and maybe the user opinions of a user forum, for example as these are representative of typical tasks. Typically she will use different sites or the results of different search engines or query processes for the different information. Sometimes the data is static, sometimes the data is dynamic (but tailored to specific queries). For purposes of this discussion, each site/engine/query may be a service having a service template and the collection of services for the task at hand defines the theme.

After spending some amount of time, a few seconds, minutes, or hours, the user will often change tasks. For example, like most users, she will decide she wants to do something else rather than explore investments. Perhaps she now wants to check out movies. Choosing a movie theme will often require reconfiguration of her preferred search configuration/approach/sites/queries and the like. Entering the movie task, such as by selecting a movie theme, reconfigures the system to make it useful for what she now wants to know about movies. For example: What movies are close by? What are names of new DVD releases? What are good movie selections matching her preferences? What are some of reviews of some of these movies? The preferred embodiments facilitate the definition and creation of themes and associated services and efficient reconfiguration of a computing system to implement theme-based resource identification/retrieval as more specifically described below. Themes and/or services developed by one user are easily shared and made available to multiple users across multiple computing environments. Users easily reconfigure their computing systems to match the task at hand.

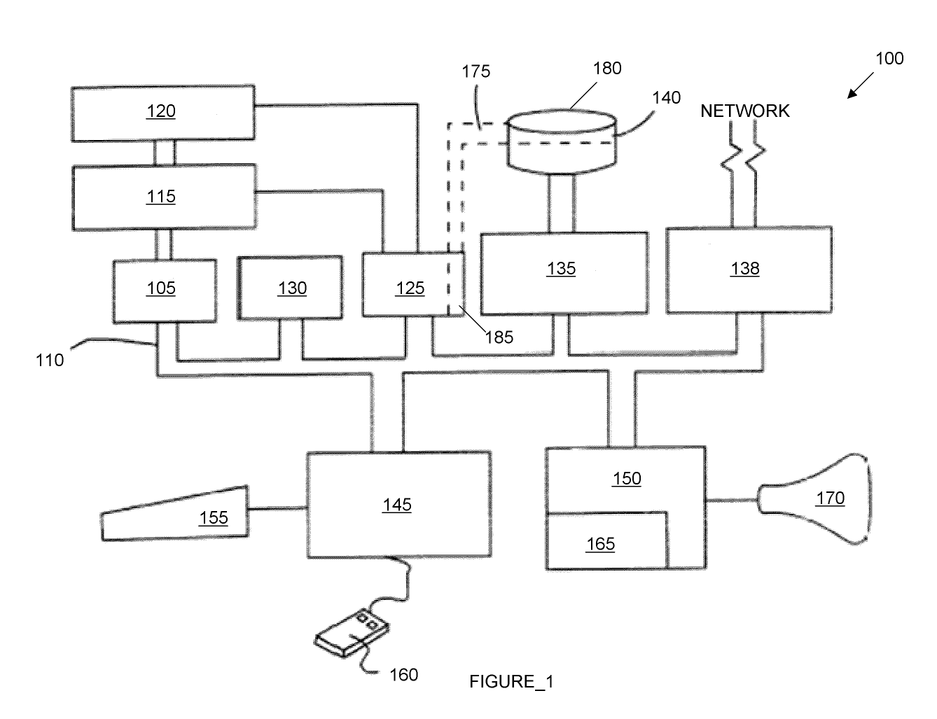

FIG. 1 is a computer system 100 that may function as a basic computer in implementing a preferred embodiment of the present invention for an efficient interface solution that provides a user with simple and quick searches across a plurality of locations, and one that may be expanded without complicated or time-consuming configuration options. Computer system 100 includes a central processing unit (CPU) 105, such as one of the PC microprocessors or workstations, e.g. RISC System/6000 (RS/6000) (RISC System/6000 is a trademark of International Business Machines Corporation) series available from International Business Machines Corporation (IBM) or other processors from Advanced Micro Devices, Intel, Motorola, MIPS Technologies, Inc., and the like, is provided and interconnected to various other components by a system bus 110. An operating system 115 runs on CPU 105, provides control and is used to coordinate the function of the various components of FIG. 1. Operating system 115 may be one of the commercially available operating systems such as the AIX 6000 operating system or OS/2 operating system available from IBM (AIX 6000 and OS/2 are trademarks of IBM); Microsoft's Windows (95, 98, ME, NT, 2000, and XP), as well as UNIX and AIX or Apple Computer operating systems. One or more application programs 120, controlled by the system, are moved into and out of a main memory RAM 125. These programs include the program of the present invention to be subsequently described in combination with local or wide-area network systems, such as for example, the Internet. A read only memory (ROM) 130 is connected to CPU 105 via bus 110 and includes the Basic Input/Output System (BIOS) that controls the basic computer functions. RAM 125, an I/O adapter 135 and a communications adapter 138 are also interconnected to system bus 110. I/O adapter 135 may be a Small Computer System Interface (SCSI) adapter that communicates with a disk storage device 140, though other well-known interfaces may be used. Communications adapter 135 interconnects bus 110 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160) are all interconnected to bus 110 through user interface adapter 145. It is through such input devices that the user may interactively relate to the programs for an efficient interface solution that provides a user with simple and quick searches\retrievals\accesses across a plurality of locations, and one that may be expanded without complicated or time-consuming configuration options according to the preferred embodiments. Display adapter 150 includes a frame buffer 165, which is a storage device that holds a representation of each pixel on a monitor or display screen 170. Images may be stored in frame buffer 165 for display on monitor 170 through various components, such as a digital to analog converter (not shown) and the like. By using the aforementioned I/O devices, a user is capable of inputting information to the system through the keyboard 155 or mouse 160 and receiving output information from the system via display 170. The system also contains a memory cache 175 which is illustrated as a dashed line outline and includes a portion 180 of a disk storage drive 140 and a portion 185 of RAM 125.

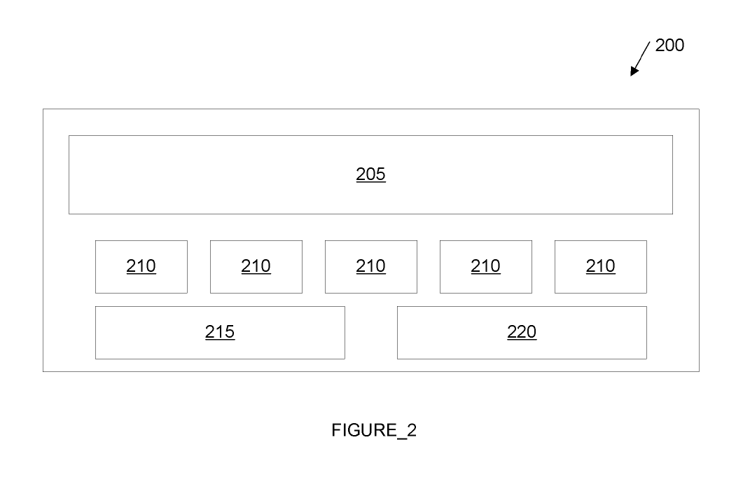

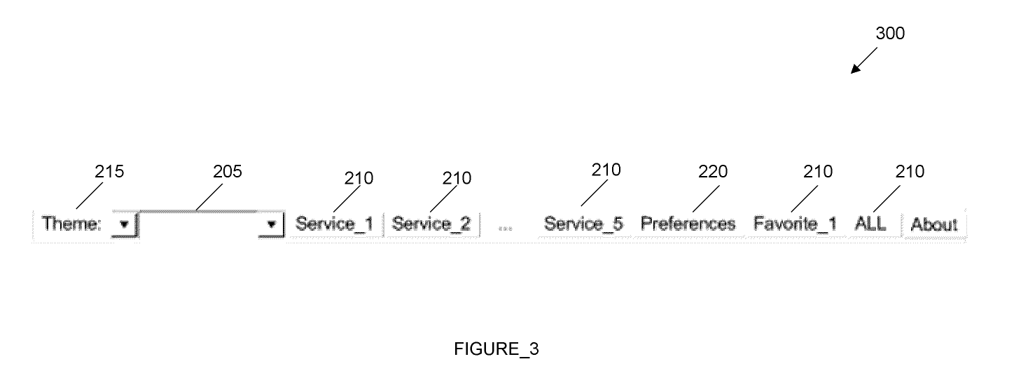

FIG. 2 is an illustration of a graphical user interface 200 for a preferred embodiment of the present invention as a stand-alone applet or process of computer system 100 or its operating system. FIG. 3 is an illustration of a toolbar 300 implementation of an alternate preferred embodiment of the present invention for an interface. Interface 200 and toolbar 300 both include a data input field 205, service actuation buttons 210, a theme/update button 215, and an account/preferences setting button 220. To simplify the following discussion, interface 200 will be understood to include both interface 200 shown in FIG. 2 and toolbar 300 shown in FIG. 3 unless expressly excepted or the context indicates otherwise.

Field 205 receives user input, typically a search query appropriate for a service function to be called. The user input is usually alpha-numeric, though other symbols, graphics or other elements may be accepted depending upon the particular implementation.

Service actuation buttons 210 are a plurality of interface elements that each initiate a different service process when selected. Each button 210 is concurrently presented with other buttons 210 and are independently actuable to direct the user input from field 205 to the identified service.

In the preferred embodiment, these services are typically search applets or databases that use the user input as all or part of a query or key to retrieval of information. For example, the United States Patent and Trademark Office maintains a website (www.uspto.gov) having several different webpages where a user may enter data to retrieve specific patent, patent application, trademark, trademark application, attorney roster, or general information. Buttons 210 may be assigned to each webpage, so that one button 210 will retrieve patent information when field 210 contains a patent number, another button will retrieve patent application information when field 205 contains a number for a patent application. Another button 210, linked to the USPTO's roster search, will return a list of registered attorneys and agents. The list has names associated to the user data in field 205 when this button was actuated.

Buttons 210 are not all limited to a single domain. Other services may include searches into databases for 35 U.S.C., 37 C.F.R., the Manual of Patent Examining Procedure (MPEP), an online (local or network) treatise, or other resource, each service potentially available from a wide variety of different domains.

In contrast to the prior art, interface 200 merges services from a plurality of different domains into one convenient location. Further, each of a plurality services are all concurrently available, the user enters an access datum (e.g., a search query) into field 205 and actuates a desired service by selecting one of buttons 210.

In the preferred embodiment, interface 200 permits the user to establish a “context” for the datum in field 205. In some implementations, interface 200 includes a context resolver (e.g., artificial intelligence, expert system, heuristic, or other decision/analysis logic) to determine a context and to identify the appropriate service in response to a single search actuation, the context identified by the datum and the available services. In field 205, for example, a number such as 5,000,000 would trigger the patent search, a number like 10/500,000 would trigger an application search, a number like 101 would trigger a search of 35 U.S.C, and a datum like “Smith” would trigger a roster search. In some cases, the user datum may include a service identifier or service command concatenated (either pre-pended or post-pended for example) to resolve ambiguities or to select a particular service (e.g., “˜pat_app#” may be a directive to interface 200 to use the patent application service and pass the # to the service. The service command may include service access, control, password or other directive/control/informational parameter.

In this configuration, the searching may be command line driven for users desiring such functionality. A user would be able to access any service from field 205 by supplying the appropriate information.

Of course, the “datum” in field 205 may be variable length and support Boolean operators or other processors appropriate to the service. In some cases, interface 200 may preprocess the user datum (or provide additional default values) appropriate for a service or as specified by the user or the service. Some additional features of these pre-processing directives are described below in the preferences discussion. In some cases, the search result may be a document, or it may initiate some other process. For example, the service may initiate a particular buying service, such as search/purchase a book at Amazon.com, or from another online merchant.

In the example given above, the services reflect a “Patent Theme” for interface 200. Service buttons 210 are configured to provide a user, perhaps a patent practitioner, with network resources that may be commonly and frequently used in her practice. It is easy to configure other collections of services for specific themes for interface 200. A stock/financial theme having service buttons 210 for stock symbol lookup, stock price, company news, Edgar database, and other investment services. Any combination of services may be combined into a theme.

Theme/update button 215 provides the user with a user-selectable list of available themes. The list is, in the preferred embodiment, a drop-down list that includes the preset themes currently available. By selecting a particular theme from button 215, service buttons 210 are configured by interface 200. In addition to identification of currently available themes, theme/update button 215 of the preferred embodiment includes an update item. This feature enables the user to update particular services or download additional themes from a theme server.

In an alternate preferred embodiment of the present invention, a user has alternate ways to update available themes or particular services of a theme. (It is understood that some services may be shared among several themes, either from the themes themselves, or through preferences/options.) Some of these ways include automatic updating by the resource when accessed using interface 200. Interface 200 and the resource (e.g., a webpage) may exchange configuration information and interface 200 would respond by either notifying the user that an update is available or that an update was made, or silently update the service (as determined by the user.) This configuration information may be available as meta-information, code, instruction or other directive (or user-accessible information in some implementations) that interface 200 recognizes as configuration information and permanently update interface 200. The update may either be a permanent addition of a new service, permanent modification to an existing service, or a new theme.

In an alternate preferred embodiment, interface 200 supports “dynamic themes” when enabled by a user. In this mode, interface 200 adapts to web pages encountered in the ordinary course of the user's activities. The dynamic configuration may be express (such as by the inclusion of meta-information in a particular web-page) or passive due to interface 200 recognizing/responding to the web page (e.g., content, meta-tags, domain name, domain type, domain extension (e.g., .com, .gov., .edu). Search engines are able to search for such configurator (dynamic or static) and return results to a user. As a short cut, the search engines may “push” service configuration to users.

Interface 200 configures service buttons 210 based upon the number of services in a particular theme, the number of service buttons 210 available for configuration, and other preferences/options associated with interface 200 or one or more services. For example, a particular theme may have six available services. Interface 200 may have a total of five service buttons 210, but the user may have identified that of these five, four are available for theme configuration.

Interface 200 optionally provides for services to be associated with particular service buttons 210 in an order determined by the theme provider, or, in an alternate preferred embodiment, each service button 210 includes a drop down list of the currently available services associated with the selected theme. The user selects which service to assign to which button 210 and which service to leave unassigned. The user may reconfigure any service button 210 with currently available options.

User preferences/options button 220 is available for the user to select available options associated with interface 200. Options may include simple interface 200 configuration options, such as a number of service buttons 210 to make available, which service buttons 210 are configurable (automatic or manually) by selecting a theme, whether any service buttons 210 are reserved/assigned for favorites or “intelligent configuration” or other service not expressly included in an available theme.

In this “intelligent mode” for interface 200, buttons 210 and themes may be added by accessing a special website/web page identifying one or more new buttons/themes. In another preferred embodiment, updates and theme addition services are available by subscription/payment to enhance functionality by adding new themes/buttons/features. Search engines may be treated like other services and made available to the user.

In the subscription/payment mode, a user has an account and stores account access information for the update service using preferences/options button 220. When checking for updates/new themes, interface 200 sends the account information to the update service for validation. A successful validation lets the user update/obtain new themes (some of which may have an associated fee).

Additionally, some services may require configuration/user information (e.g., login/passwords). While some services use various data persistent data elements (e.g., browser “cookies”), others require a login for use. Interface 200 may include user options associated with such themes to provide the login/password or other access information. Further, some services may be made directly available from interface 200 that would not otherwise be available.

In some services, there may be multiple query/service access options and fields that could access data entry. Interface 200 includes several different options for addressing these situations. In a simplest case, the user actuates a multi-entry service by selecting the corresponding service button 210 without any service data in field 205 (though service directives may be entered). Interface 200 thereafter provides the user with a multi-entry system, either native to interface 200 or opens the standard resource interface page.

Another option interface 200 provides includes use of delimiters in field 105 that the user inserts to separate the individual entries. For example, a tab-character or an infrequently used character (e.g., “˜”) or set of characters could be used. A user may enter “Company˜Name” into a “Detailed Search” service and interface 200 would parse the data entry and provide “Company” for an assignee search and “Name” as an inventor search. Interface 200 assigns, in this example, data in variable order. A user inserts null data into a field by duplicating the delimiter. For example, a service accepts up to three variables: v1, v2, and v3. Submitting all three would be: data_1˜data_2˜data_3. However, a user wishing to enter data for v1 and v3 without v2 would enter data_1˜˜data_3.

A further option, for services that have multi-field entry and the user provides less than a complete set of parameters for all the fields, interface 200 optionally stores default variables to add to the contents of field 205 when such a service button is actuated.

As an aid to the user for multi-field entry, a “tool tip” help pop-up may be provided to identify for the user the variable order. That is, hovering a cursor over a multi-field entry service, a tool tip advises the user that data may be entered in PatNo, Assignee, Inventor order, for example. An inventor name search would therefore become: ˜˜Name. When variable order runs from most commonly used to least commonly used fields, interface 200 offers the user a particularly efficient tool. Interface fills unidentified variable fields when parsing with nulls or default values as specified by the preferences/options. In some implementations, interface 200 provides the user with an ability to change the variable order, in addition to adding theme-field-specific default values. That is, for theme one, v2 may default to a first value while for theme two, v2 defaults to a second value different from the first.

An additional navigation ability offered by interface 200 is meta-data navigation. In meta-data navigation, certain resources/webpages are identified by a label or tag and accessed via these labels/tags rather than the content of the resource. For example, various resources in a domain may be identified as “home” “database access” “contact info” or any other feature. Entering an appropriate meta-label into field 205 and actuating service button 210, the user is navigated to the particular resource/webpage.

Toolbar 300 illustrates additional service buttons 210 to those shown in FIG. 2. Specifically, a Favorite_1 and an ALL service button 210. (Interface 200 is configurable to include these option buttons as well.) The user configures toolbar 300 to define a particular number of service buttons 210, and how many of these buttons are automatically configurable by a theme selection using theme/update button 215. For toolbar 300, two buttons are special purpose buttons, the Favorite_1 and the ALL service button.

Favorites permit the user to “lock” a service button 210 to a particular service and have it available across themes and any dynamic or intelligent configurations. Similarly, the ALL service button 210, initiates services from a plurality of the buttons 210 (specific ones depending upon the user's options/preferences) when it is actuated. In the preferred embodiment, toolbar 300 actuates each service independently as if it had been initiated by itself. However, in some implementations, toolbar 300 performs post-processing on the service conclusion (e.g., merge results or send all results to a printer).

Display 170 presents interface 200 and a pointer (e.g., a cursor) controlled by one or more I/O devices. CPU 105, executing instructions received from memory, renders interface 200 on display 170 and monitors the cursor's location when certain signals are sent from an I/O. When the cursor's position corresponds with one of the actuable features of interface 200, CPU 105 implements additional instructions appropriate for the particular feature (e.g., a particular button 210). The additional instructions implement the system and method described above for the manufacture and use of the preferred embodiment for interface 200.

In another preferred embodiment of the present invention, interface 200 supports key_assignments to uniquely associate available services to specific key combinations. In reviewing any resource (e.g., a word processing document, a spreadsheet, a web page, data in a data entry field of a process) a user may identify an element (e.g., a word, phrase, or number) of the resource (e.g., using a cursor positioned in/on the element or highlighting the element) and expressly or implicitly actuating the desired service using the key_assignment or other actuation mechanism. The element is passed to the service and interface 200 processes the element, for example just as if the user had manually entered the element into interface 200 as described above. In the patent theme as discussed above, a user in reviewing a patent-themed resource, whenever a patent/application number, a U.S.C. or MPEP section, an inventor, or a practitioner appears, the user simply identifies these elements in the resource and initiates the desired service (unless it is determined heuristically as described herein). The elements may be passed individually or in “batch” mode, and the results may be aggregated into a single result list or multiple lists of results.

In some implementations, the user applies (manually or automatically) a theme to the resource which determines appropriate theme-elements (such as through pattern-matching/lookup) to identify elements in advance and retrieve them in a background mode during a user's review of the resource. For example, all the patents, patent applications, code sections, etc. are retrieved and available immediately for further access and review by the user. Implementations may limit the degree to which this “look ahead” prefetches resource elements for the user. As discussed above, the services may be premium (e.g., subscription based) proprietary or publicly available services that retrieve a result triggered by the input element or it may initiate a process based upon the input element (print a resource, burn a CD, buy a book, or other process initiated through a web browser or other process implementing interface 200.).

In the event that themes and associated elements are standardized, metadata associated with a resource (e.g., data in a header or an associated document/database entry) may uniquely identify a specific theme and consequently specific elements of the resources, and that identification is reproducible. This creates a type of dynamic hyperthreading in which resources are not specifically identified in advance. Rather, an element has a specific result when applied to a specific service and that result is dynamic, though in one sense it is determined in advance by identification of the service. For example, in the patent themed interface 200 that uses pattern matching to identify patent numbers by parsing and matching a document text to a template: “USx,xxx,xxx” and associating patents to a patent_processing_service, associating the specific theme to a specific resource reproducibly identifies the same elements as patent numbers and reproducibly processes those patent numbers by the patent_processing_service. Making a global change of the associated service in the theme, for example changing the associated service from a viewing service to a printing service, effects the desired change when accessing the resource to print the patents rather than simply viewing them.

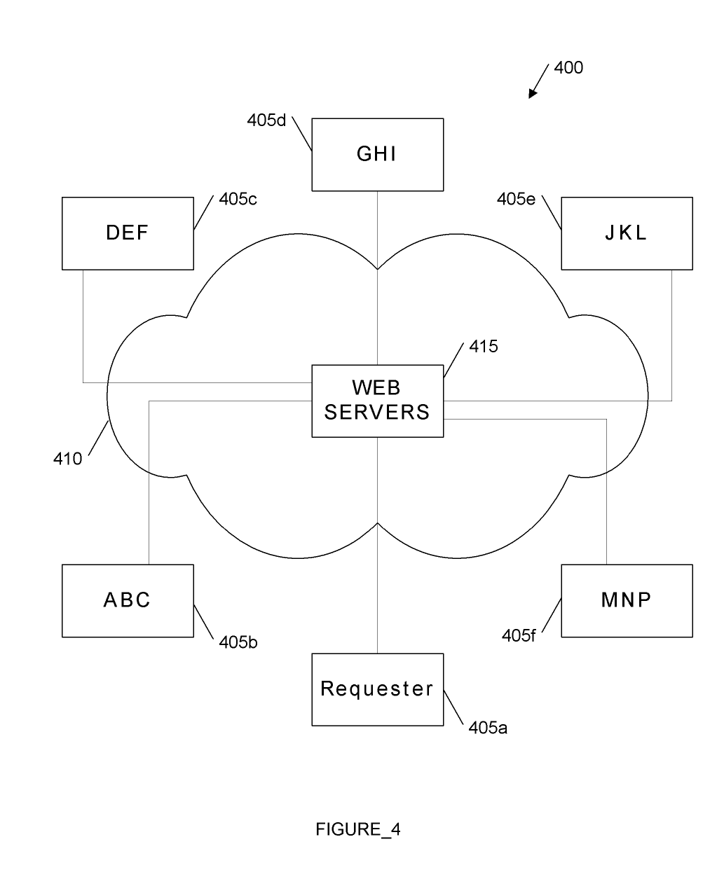

In FIG. 4 a distributed data processing system or computer network 400 is schematically shown. The computer network 400 may be for example a local area network (LAN), a metropolitan area network (MAN), a wide area network (WAN) or a network of networks such as the Internet, and comprises a plurality of computers, computing systems, electronic devices and the like 405a-405f interconnected to each other and to one or more network servers 415 by a data communication infrastructure 410. A specific one computing system 405a is configured with an interface of a preferred embodiment of the present invention.

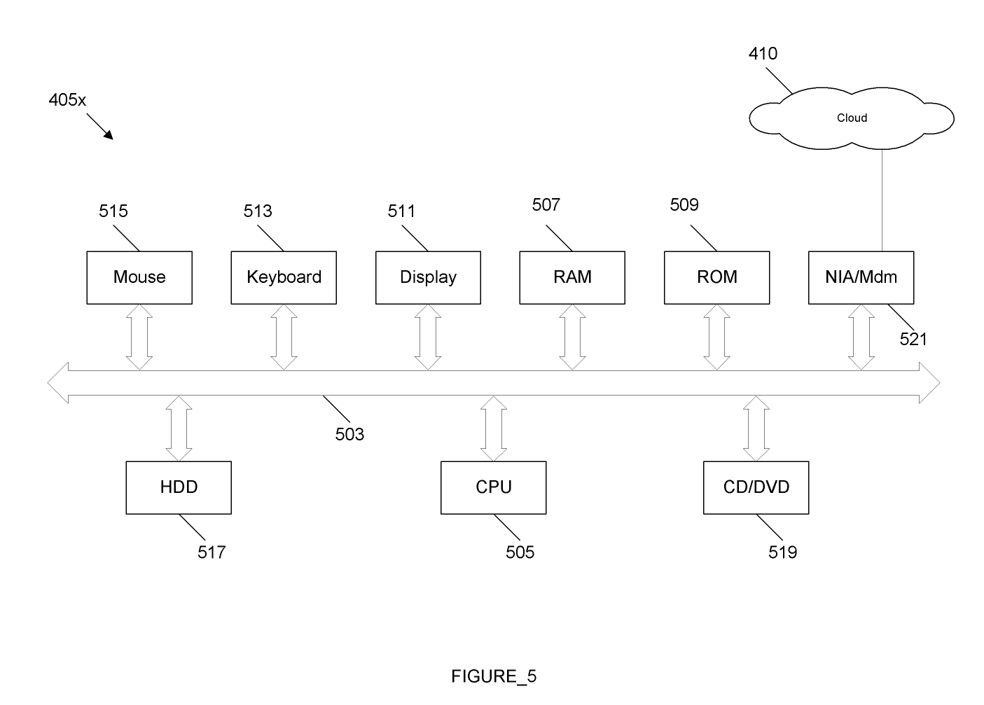

As schematically shown in FIG. 5, a generic computer of the computer network 400, e.g. the computer 405a, includes several functional units connected in parallel to a data communication bus 503, for example of the PCI type. In particular, a Central Processing Unit (CPU) 505, typically comprising a microprocessor, controls the operation of the computer 405a, a working memory 507, typically a RAM (Random Access Memory) is directly exploited by the CPU 505 for the execution of programs and for temporary storage of data, and a Read Only Memory (ROM) 509 stores a basic program for the bootstrap of the computer 405a. The computer 405a comprises several peripheral units, connected to the bus 503 by means of respective interfaces. Particularly, the peripheral units that allow the interaction with a human user are provided, such as a display device 511 (for example a CRT, an LCD or a plasma monitor), a keyboard 513 and a pointing device 515 (for example a mouse or a trackpoint). The computer 405a also includes peripheral units for local mass-storage of programs (operating system, application programs) and data, such as one or more magnetic Hard-Disk Drivers (HDD), globally indicated as 517, driving magnetic hard disks, and a CD-ROM/DVD driver 519, or a CD-ROM/DVD juke-box, for reading/writing CD-ROMs/DVDs. Other peripheral units may be present, such as a floppy-disk driver for reading/writing floppy disks, a memory card reader for reading/writing memory cards and the like. The computer 405a is further equipped with a Network Interface Adapter (NIA) card 521 for the connection to the data communication network 410; alternatively, the computer 405a may be connected to the data communication network 410 by means of a MODEM. Of course, computer 405x could also be configured according to FIG. 2 as well-known, with FIG. 2 and FIG. 5 describing alternative systems.

Any other computer 405b, . . . , 405f in the computer network 400 has a structure generally similar to that depicted in FIG. 5 (or FIG. 2_, possibly properly scaled or alternatively configured depending on the machine computing performance, computing tasks, and implementation details).

The computer network 400 supports “browsing” using various World-Wide Web (WWW) protocols such as hyper-text transport protocol (HTTP), hyper-text markup language (HTML) and other well-known standards (and future standards) relating to resource identification, access, and retrieval protocols and services, enabling users of the computers 405a-405f to identify, locate, access, and retrieve network resources, web pages, search engines, and query processes. The details of these protocols and services are known per-se and will not be described in depth. Resources, web pages, search engines, and query processes are accessed using an identifier that may be of the Uniform Resource Locator (URL) type or other standard for identification and access as described herein. A URL is often of the format protocol://address such as “http://www.domain.tid” or “ftp://www.somedomain.com” or the like.

One or more computers 415 in the computer network 400 act as web server computers (shortly, servers), managing the distribution of web messages coming from different users to the intended recipients. Web software is designed around a distributed client-server architecture. A Web client (called a Web browser when it is intended for interactive use) is a program which can send requests for documents to any Web server. A Web server is a program that, upon receipt of a request, sends the document requested (or an error message when appropriate) back to the requesting client. Using a distributed architecture means that a client program may be running on a completely separate machine from that of the server, possibly in another room or even in another country. Because the task of document storage is left to the server and the task of document presentation is left to the client, each program is able to concentrate on those duties and progress independently of each other. Because servers usually operate only when documents are requested, they add a minimal amount of workload to the computing systems they operate on.

The following is an example of how the process works: 1. Running a Web client, the user selects a hyperlink in a piece of hypertext connecting to another document—“The History of Computers”, for example. 2. The Web client uses the address associated with that hyperlink to connect to the Web server at a specified network address and asks for the document associated with “The History of Computers”. 3. The server responds by sending the text and any other media within that text (pictures, sounds, or movies) to the client, which the client then renders for presentation on the user's screen.

The World-Wide Web is composed of thousands of these virtual transactions taking place per hour throughout the world, creating a web of information flow. Future Web servers will include encryption and client authentication abilities—they will be able to send and receive secure data and be more selective as to which clients receive information. This will allow freer communications among Web users and will ensure that sensitive data is kept private. It will be harder to compromise the security of commercial servers and educational servers which wish to keep information local. Improvements in security will facilitate the idea of “pay-per-view” hypermedia, a concept which many commercial interests are pursuing.

The language that Web clients and servers use to communicate with each other is called the Hypertext Transfer Protocol (HTTP). All Web clients and servers must be able to speak HTTP in order to send and receive hypermedia documents. For this reason, Web servers are often called HTTP servers. The phrase “World-Wide Web” is often used to refer to the collective network of servers speaking HTTP as well as the global body of information available using the protocol.

The World-Wide Web uses what are called Uniform Resource Locators (URLs) to represent hypermedia links and links to network services within HTML documents. It is possible to represent nearly any file or service on the Internet with a URL.

The first part of the URL (before the two slashes) specifies the method of access. The second is typically the address of the computer the data or service is located. Further parts may specify the names of files, the port to connect to, or the text to search for in a database. A URL is always a single unbroken line with no spaces. Sites that run World-Wide Web servers are typically named with a www at the beginning of the network address.

Here are some examples of URLs:

file://www.site.edu/sound.au—Retrieves a sound file (identified by the “au” extension and plays it when the extension is associated with an appropriate player process.

file://www.site.org/picture.gif—Retrieves a picture (GIF extension) and displays it, either in a separate program or within a hypermedia document.

file://www.site.gov/directory/—Displays contents of the specified directory

http://www.site.net/directory/book.html—Connects to an HTTP server and retrieves an HTML file (i.e., book.html).

ftp://www.site.com/pub/file.txt—Opens an FTP connection to www.site.com and retrieves a text file (file.txt) from the pub directory.

gopher://www.site.edu—Connects to the Gopher at www.site.edu.

telnet://www.site.edu:1234—Telnets to www.site.edu at port 1234.

news:alt.hypertext—Reads the latest Usenet news by connecting to a user-specified news (NNTP) host and returns the articles in the alt.hypertext newsgroup in hypermedia format.

Most Web browsers allow the user to specify a URL and connect to that document or service. When selecting hypertext in an HTML document, the user is actually sending a request to open a URL. In this way, hyperlinks can be made not only to other texts and media, but also to other network services. Many Web browsers are not simply Web clients, but are also full-featured FTP, Gopher, and telnet clients, and other protocols may be supported (directly by the browser or through helper applications/processes) now and in the future.

HTML+ is expected include an email URL, so hyperlinks may be made to send email automatically. For instance, selecting an email address in a piece of hypertext would open a mail program, ready to send email to that address.

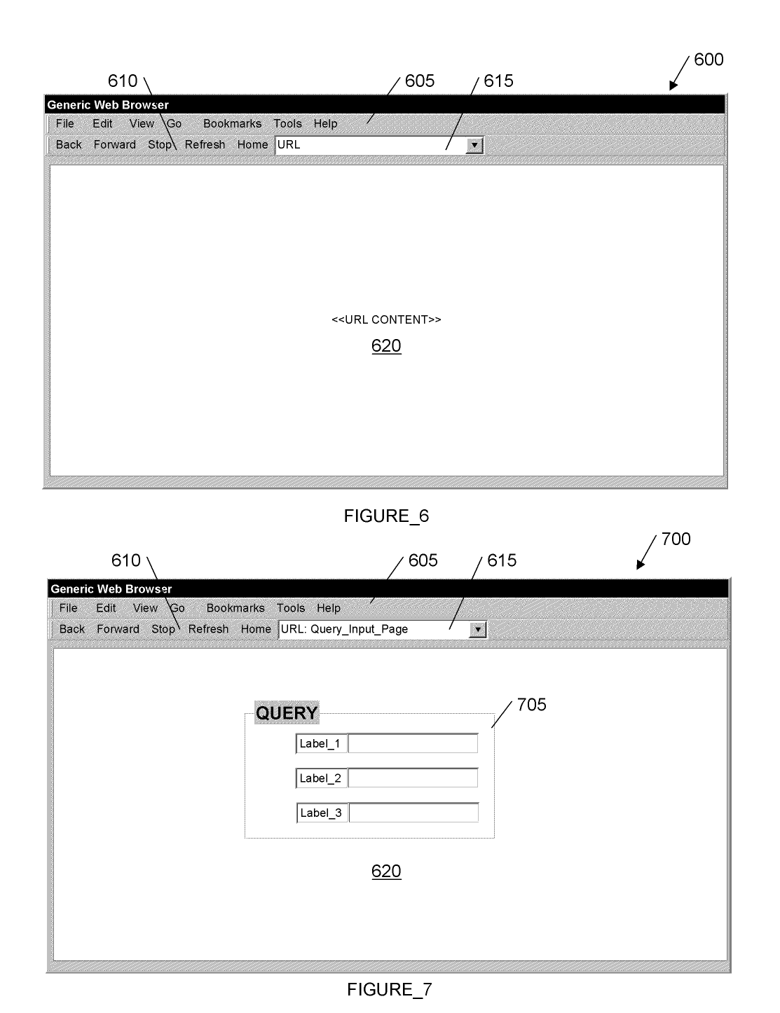

FIG. 6 is an illustration of a generic browser 600 depicting a typical configuration. Browser 600 includes a menu bar 605, a navigation bar 610 including an address control 615, and a content window 620. Menu bar 605 may include options for “File,” “Edit,” “View,” “Go,” “Bookmarks,” “Tools,” and “Help” for example though different browsers 600 may include different content and/or arrangement of menu bar 605 elements.

Navigation bar 610 includes elements for “Back,” “Forward,” “Stop,” “Refresh,” and “Home” elements in addition to address control 615 for navigating among URLs as well-known. Entry of a URL into address control 615 and “actuation” of the URL (such as by “return” or execution of a “Go” option or the like for example) causes browser 600 to locate and retrieve the identified resource into content window 620.

It is common to begin many tasks with browser 600 by entering a URL of a general purpose search engine such as “http://www.google.com,” “http://www.yahoo.com,” or “http://www.msn.com” or the like.

FIG. 7 is a reconfigured web browser 700 in which a query_input URL has been specified for browser 600 shown in FIG. 6. Browser 700 includes a query dialog 705 in content window 620 when the URL identifies a resource having controls for receiving input into a search engine or other query input. Query dialog 705 varies from search engine to search engine and from query_process to query_process, and from one instantiation to another instantiation. Query dialog 705 is a generic representation of typical query dialogs that include one or more input controls (input text boxes, drop down lists, combo lists, and the like) with labels identifying the type of input to be provided using the associated control. The number and type controls and labels also varies from search engine to search engine and from query_process to query_process.

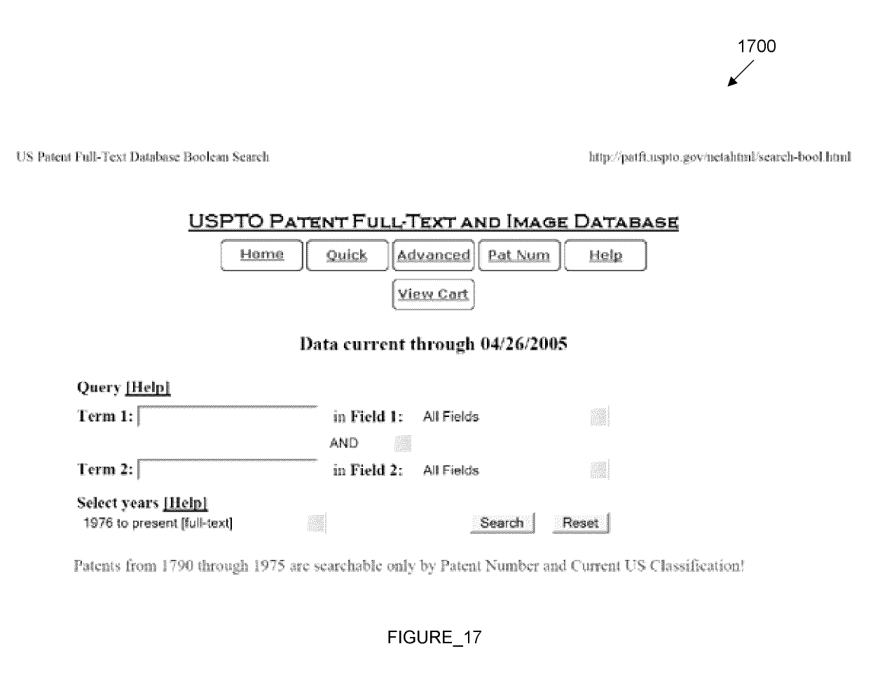

For example, at www.google.com as the URL: Query_Input_Page entered into address control 615, a single query input box is provided, labeled as a Google Web Search. However, at patft.uspto.gov/netahtml/search-bool.html (a “quick” search option from the Patents sub-site from the USPTO main website at www.uspto.gov includes a query process 1700 shown in FIG. 17) there are two text input controls (labeled Term1 and Term2) and four drop-down controls (including Field1, Field2, the logic operator and year selector), all for configuring and launching a desired search among the records at the United States Patent and Trademark Office. The number and configuration options for query 705 are practically unlimited.

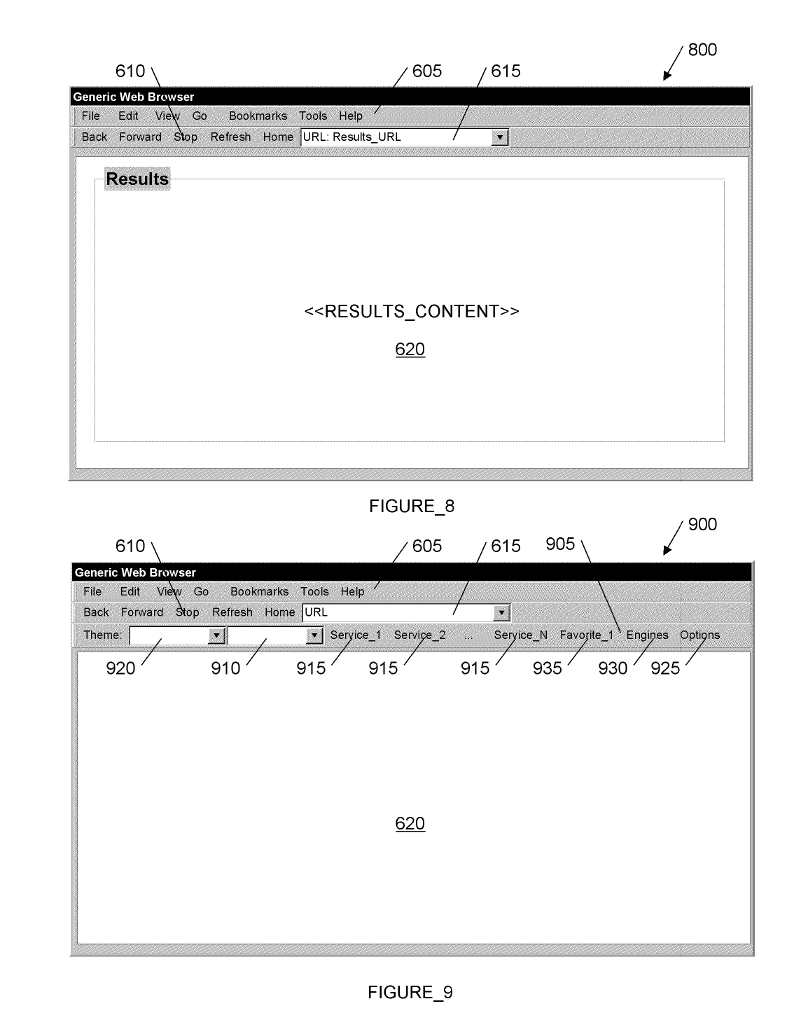

FIG. 8 is a reconfigured web browser 800 in which a Results_URL URL has been specified for browser 700 shown in FIG. 7. Browser 800 includes the results content specified for the results_URL in content window 620. Results_Content, determined by the application of the query options into the query process identified by query dialog 705, may be <<null>>, a single resource (which may include another query dialog, the same or different as query dialog 705) or an aggregated list of resources, one or more of which may be a URL including another query dialog 705.

FIG. 9 is a reconfigured web browser 900 in which a preferred embodiment of the present invention for an interface control 905 (e.g., a toolbar) is included. Interface control 905 is a variation of interface 200 and toolbar 300 shown in FIG. 2 and FIG. 3 respectively, and the controls are similar in operation to those of the earlier described embodiments. Interface control 905 includes a data input field 910 (e.g., input 205), one or more (e.g., N number, N dependent upon user preference and resolution) service actuation controls 915 (e.g., buttons 210), a theme selector control 920 (e.g., button 215), and an account/preferences/options setting control 925 (e.g., button 220), as well as an engines control 930 and favorite control 935, each of which is a special purpose type of service control 915 as described below.

In addition to the functions described above for interface 200 and toolbar 300 implemented using the related controls, interface control 905 includes additional functionality. While interface control is shown integrated into a web browser, interface control may be provided as part of other applications/processes or even as part of a stand-alone application/process such as shown in FIG. 2. In general, interface control 905 is configurable from a database (local or remote relative to the computing system/process supporting control 905) for collecting, identifying, retrieving, and implementing themes and associated services as further described below. Associated with the service control 915 of each theme identified by theme selector 920, is a service template. Each service template includes one or more attributes that are determined by implementation. In the preferred embodiment, these attributes include a root URL map, a default URL map, a label, and tooltip text. Each selected theme dynamically reconfigures interface control 905 with the appropriate service templates, and interface control 905 thereafter responds to actuation of a service control 915 as further described below.

In the terminology of the preferred embodiment, a theme is a set of several related web resources defined by admin or user (which may include attributes such as, for example, ownership which may include denomination as a public, system, or private theme), the relationship exists by association of the resources together into a theme. The resources are called services. Any number of services may theoretically be assigned to one theme during creation or editing, but practically the preferred embodiment chooses a relatively arbitrary number as MAX_NO services, MAX_NO preferably is equal to about six services. Thus, number of services per theme could, in general, be variable from theme to theme and users, in general, could specify a particular number of services of a theme to display concurrently. In the preferred embodiment, all services are loaded, with a user determining how a MAX_TOOL_NO of services to load of a theme (such as when the user has a resolution does not permit all services to be displayed concurrently). The services which exceed the MAX_TOOL_NO (if any) are presented in a drop down menu appended onto a control or otherwise inserted into the toolbar/interface.

For example, when a user has a relatively low screen resolution (that would not support many controls on a single line), the user may set the interface with three service buttons when MAX_NO could be six or more. So, services 4, 5, 6, and 7 will be moved to the drop down menu. When the resolution is high and may properly support more controls, the user may set MAX_TOOL_NO to six so only service 7 will be in the drop down menu. All services of a loadable theme are loadable by every user qualified to load any particular theme, as explained in more detail below.

In an alternate embodiment, the interface may permit a user to load a subset of services from the set of services associated with any given theme. In other words, the user determines which services from a theme to use. For example, a theme contains ten services and user specifies that only the 2nd, 3rd and 7th of them are needed, thus only 3 service buttons will be shown on the interface and associated with the specified/needed services. In either implementation, it is preferred that the service order is selected by the theme creator, however in some implementations it may be desirable to permit a user to also select a service order for the service templates. Unused actuation buttons of a theme may default according to user preferences, such as for example to one or more additional “favorite” buttons for example.

The preferred embodiment includes three major components:

1) A User Interface (e.g., the toolbar);

2) A Local Application/Process supporting the user interface, and

3) A Remote Webservice

The Interface

The preferred implementation for the interface includes a toolbar built into a web browser window (e.g., Internet Explorer) such as interface control 905 shown in FIG. 9. Theme selector control 920 lists themes which have been chosen by the user using the webservice/server and which have been loaded and are available for current use; where loading of a theme automatically reconfigures the service controls with service templates. Data input field 910 is an editable drop-down textbox where the user enters content for placeholder dynamic substitution into templates associated with the services buttons. This content will be used as a value for placeholders (as described below).

Service 1 . . . Service N are service actuation controls 915 whose backend/template depends on the selected theme. Each service actuation control 915 of the preferred embodiment has various attributes loaded from the webservice appropriate to the user and to the selected theme, including: a) an associated button Label; b) a root URL; c) a default URL; d) one or more placeholders; and e) tool tip help. In other implementations, other attributes may be used. For example, in some instances it may be desirable to include attributes that define a number of placeholders, the placeholder symbol to be used for replacement in the service link (the preferred embodiment uses a standardized placeholder across templates/services).

Tool tip is just an attribute of each service button that may be used as an aid to the user. Given the limited screen space, a theme/service designer may use the tooltip to guide the user as to what function a button performs, or the type of input the service responds to. For example, a theme creator could provide a tooltip that specifies the kind of input or format for the input or other details of the service. In other words, the tooltip could be: “USPTO Patent Number search—numeric input—n,nnn,nnn” that specifies a format where “n” indicates a Arabic numeral. Tool tips include textual information which is added and edited by an administrator or theme creator.

Favorite control 935 is a special purpose service actuation control 915 that includes attributes that have been copied from one of the dynamic service buttons—the definition is static and persists across theme changes until manually changed by the subscriber/user. Favorite control 935 is defined locally by the user. In the preferred embodiment, favorite control 935 is defined by right clicking on the service button and then choosing ‘add to favorite’ or by dragging a desired service actuation control onto favorite control 935.

When service attributes have been previously assigned to Favorite control 935, dragging and dropping a subsequent service actuation control onto the favorite control reassigns the service attributes. Favorite control 935 includes a set of default attributes determined by the administrator that persist until reassigned.

Engines control 930 is, in the preferred embodiment, a type of special theme relating to search engines. Engines control 930 provides a set of online and desktop search engine templates from which a users may define a persistent subset of search engines that respond to actuation. For example, Google, Yahoo, and MSN are well-known online search engines and Google desktop Search is a suitable desktop search engine that may be used in cooperation with the preferred embodiment, though other search engines may also be templated for use. Search engines defining the set of search engines are identified in the webservice, which permits later addition/modification by an administrator like other types of service templates).

In the preferred embodiment, the SuperAdmin adds any web search engine that may be templated as described herein through use of the same tool which used for theme creation, with the “theme” in this case the special search engine list associated with engines control 930. The administrator sets the number of online search engines adding new ones anytime, and the modified list is made available to a user such as when the user logs into the webservice and downloads/refreshes the interface themes. Accounts denominated at a SuperAdmin privilege level will be the only accounts allowed to add/edit the search engine “theme” in the preferred embodiment. While the search engine services for this special theme are also service templates, they are loaded specially as they are associated with engines control 930.

Associated with each search engine service in the search engine theme is a flag, settable by the user and persistent across logins, to determine which subset of services respond to the actuation of engines control 930. The interface provides a mechanism to set/clear these flags, which in the preferred embodiment are checkbox controls for each search engine. Those engines having a “checked” checkbox respond to engines control 930, while engines associated with unchecked controls do not respond to engines control 930. In the preferred embodiment, the editor ensures that the search engine services are compatible with the interface (e.g., in some implementations it may be preferable that none of the services associated with the SE button include more than one dynamic primary placeholder). In the preferred embodiment, a user has an option to determine whether each active search engine service associated with the SE is launched in a separate window in response to actuation of the SE button, or whether an aggregated list of search results are produced.

In a preferred embodiment, the tool/interface combines features of Favorite control with the Engines control to enable a user to assemble a custom collection of service templates appropriate for their task. This is a more generic solution to the Engines control as that system was designed for multipurpose search engines. In this implementation, combining the favorites and the engine controls permits a user to assemble a collection of templates and selectively actuate one or more of them on a query. In this example, any service template may be used and is not limited to “search engine” templates. For example, such a favorite engines control for patent prosecution may respond to a patent number to access the patent office web site (for full-text), access an online patent copy service (to obtain an image of the patent), search the Federal Circuit case service for the patent number, access technical news sites for articles about the patent number, and the like. Other combinations and purposes of a favorites engine are also possible, based upon user preferences, tasks, and configurations.

Control 925 enables selection of some of the subscriber local options, including in the preferred embodiment: a) about, (Version, copyright/patent notices, and the like); b) System Data entry/review/modification (e.g., system data may include user data that was independent of any theme, such as name, address, zip, standard login, standard password, age, birthdate, and the like); c) privacy controls for some or all secondary data (volatile or nonvolatile storage between sessions of login/passwords information), (for example whether to login each time a new browser is launched or whether login/password data (either the system values or the service specific login and/or password) is preserved in the webservice after the user logs out)—one implementation is that a service_login_lD secondary data field and/or a service_login_PW secondary data field could be set to be non-persistent so that the first time that the service is launched after login, the data is treated as dynamic secondary and, when null/missing, the user is requested to enter the missing data—the preferred embodiment uses privacy controls to implement user desired levels of security; d) to reuse a browser window or launch a new browser window in response to service control actuation; e) to disable error reporting; and f) Recommend/request theme/service. The recommend option permits a user to send a support request to the webservice in order to create/edit and produce a custom theme/service for the user or system. In operation, the user opens a webpage in their browser from which the user wants to use as a base for a theme/service. The user operates the “recommend” control to produce a dialog control that includes a comment field with the request. This feature sends the request with the URL of the page and the comments from the user to an address (or addresses) determined in the administrator function).

In describing the URLs and templates associated with the preferred embodiment of the interface, there are two modalities for the URLs: 1) a direct substitution (DS) modality and 2) a non-direct substitution (NDS) modality. In the DS modality, each service has a predefined default URL template, for example including a URL of the form: www.service_n.com/?q=<<placeholder>> as the root URL (this is the URL of the type for direct substitution). This is an example of a configuration template for a service. (It is often the case in the preferred embodiment that the DS root URL has the www.service_n.com/?q=<<placeholder>> format, wherein the associated default URL will often be www.service_n.com, though sometimes it is not as the search query screen is deeper in the webstructure. The default URL of the preferred embodiment is often a specific page from which the user could manually enter the same data used by the template/service template. It is frequently useful for query pages/engines accepting more than a single input or other complex interface options.) In a broad sense, a default URL may just be a useful synergistic URL for the root URL associated with a service actuation control.

Also, please note: to simplify this discussion, the preferred embodiment provides examples using URLs accessible using HTTP. However, not all URLs will be limited to this protocol, as in some cases it may be desirable to implement a protocol using FTP, TELNET, FILE, GOPHER, and other protocols compatible with a browser or other process/application having an associated interface of the present invention.

The interface of the preferred embodiment creates a pseudo-dynamic URL based upon user input and configuration/template information, and in some cases pseudo-static URLs. The interface generates a different pseudo-dynamic URL—and then a browser window is launched to retrieve the resource (often a webpage or document). This discussion relates to the service_N actuation controls. The Service_N actuation controls have different URL templates associated with them, the templates being the pseudo-dynamic URL (also sometimes referred to herein as the root URL) and default URL, and may have one or more placeholders, each of which may be static or dynamic.

There are two types of pseudo-dynamic URLs in the preferred embodiments: 1) (the DS modality) is the type where the search engine/query is included in the URL: e.g., www.google.com/?q=<<placeholder>> and 2) (the NDS modality) is the type where the interface navigates to a query input URL and loads predetermined fields of the query and then executes the search engine/query. For example, query process 1700 shown in FIG. 17 may be mapped to denominate one or more of the input/dropdown controls as placeholders for a service template. Other systems may use additional or different types of service templates.

For the DS modality, when new input is made in data input field/control 910, the root URL from the webservice is launched in which the input text/system data REPLACES all instances of the dynamic placeholder symbol(s). After launching (new window/old window as determined by user option) the preferred embodiment clears data input field 910 (though the entry remains in a history associated with the control for later (re)selection.) In the preferred embodiment, when no new user input is present in data input field 910, then the default URL associated with a service actuation control is launched instead of the root URL. However, it is possible that a pseudo-dynamic URL is actually static (in the sense that the entire URL is predetermined by available information and no “dynamic” data is needed from the user (a static URL may include variable predefined information from the webservice/database file but it is static in the sense that the URL is not expected to change on each service actuation). In cases like this, there is never any new input into the text box to distinguish (on this basis) between selecting the default or the root URL. In alternate preferred embodiments, it is possible for the interface to use clicks, alt-clicks, shift-clicks, and control-clicks for different functions, among other variations. A regular click (or the hotkey as explained below) launches the root URL, another kind of click launches the default URL, another type captures the browser URL into the button/editing/creation system—for example.

HotKeys

Once an application/process such as the web browser is configured with a preferred embodiment of the interface as described herein, the user may then recursively/reiteratively apply the configuration options to the content of the resource, such as by highlighting a word or phrase in the document (like a word document, a spreadsheet, a PDF, or a webpage and the like) and using that as input into the pseudo-dynamic generation process. The preferred embodiment of the present invention includes “hot key” assignments for each service actuation control, the favorite, and the SE button. Activation of the service template associated with these controls is accomplished by selecting the appropriate hotkey. When a selection is identified (e.g., highlighted text) and the hotkey is activated, the selection is used as if the user typed in the selection into the input box and thereafter actuated the service actuation control. A preferred implementation includes: the content of the Window's clipboard is copied into the input box. The hotkeys are configured like Ctrl+c+#. Then the proper pseudo-dynamic link will be generated and a proper page opened in the browser. The history of data input control 910 may also be activated by the user with a hotkey, and thereafter scroll up/down to identify a value for input into a service template. Other hotkey solutions may be implemented in a different but acceptable manner. A key feature is to enable a simple reiteration/recursion of content of a webbrowser back into templates associated with service actuation controls selected by a theme. As noted above, in some preferred embodiments, heuristics (e.g., pattern matching with a service template (e.g., with a validation control) and content in the application/browser may automatically launch the template and the content matching the pattern. Other heuristics may employ custom dictionaries or search/interface history.

In some instances, a site may require that a user “log in” before being able to access a search query web resource and consequently many such sites do not permit landing on certain pages by direct link (an example of a DS modality). Often such sites just redirect users to the log-in page. When a user logs in they may open either the DS link or the homepage of the site. Some configurations of sites may require special interface configuration, or website configuration to work with all aspects of the preferred embodiments. Note: the NDS modality will often permit a service template to login to a login-required URL even should DS direct link be unavailable. Some sites store cookies or generation other indicia of authentication which, once activated, may permit DS/NDS template operation.

Once a user logs into the webservice, preferably using the interface, the application and/or the interface checks the server for user's selected themes and downloads them. Before this the dropdown list of theme selector control 920 is empty, also in the preferred embodiment theme selector control is empty until the user chooses a theme from a populated dropdown list. Also in the preferred embodiment, a user may set a theme as the home or default theme, so that the tool having loaded the themes list opens this ‘home’ one automatically. (This feature may be better implemented in a tab-enabled browser, like Firefox) to launch tabs instead of new windows. In other preferred embodiments, it is an option to pre-populate a theme list with a limited set of themes (maybe as few as one) and may include certain useful themes (e.g., sponsored themes).

Placeholders

The preferred embodiment develops a common set of placeholders common to many services and users as system placeholders. Things like name, address, city, state, zip, country, phone, default userid, and default password may be commonly used. A user may either configure manually in advance of use or any system placeholder having a null/unknown value is queried using a pop-up feature when the template is launched. In the preferred embodiment, system data/system placeholder data is stored in the webservice making the interface useful across different computing systems. In some implementations, it may be desirable to make a stand-alone version of the interface in which case all configuration/ini data is stored locally. In other cases, such as for privacy concerns, some or all of the secondary data may be stored locally. In still other cases, encryption may be used for particularly sensitive data, the encryption applied to either webservice data or local data at an option of the user, which combined with a “flush” option for removing sensitive system/user data, provides enhanced protection for privacy implementation.

For example, when a user has not entered zip code information and they activate a root URL that includes a secondary placeholder that is mapped to the system zip code for the user, the interface presents a pop-up dialog requesting missing placeholder information and stores that info in the webservice as the user zip code. Until cleared, subsequent placeholder requests for the user zip code use the value in the system data storage. Options and configuration information are preferably stored in the webservice database for each user. Users will be allowed to change placeholder static values. Each service template includes a way to set any associated dynamic secondary data fields as “dirty” meaning that the template should requery for user value change upon actuation. During service definition, a dynamic secondary placeholder may be mapped to a system value (in which case it always gets refilled with the same data until the data is changed at the website) or the dynamic secondary data is just mapped to a template-level variable (which could be zip) so that a user may enter/set different zip codes for different templates.

Each service root URL is basically a URL template, having zero placeholders (for static URLS) to potentially many placeholders. These placeholders are filled with user input (either from the data input field, the secondary data from the webservice database, or a pop-up window dialog. In the preferred embodiment, practically every service template has a placeholder, at least one. These placeholders are variables that are substituted when the URL template is launched. In the direct substitution (DS) modality, the preferred embodiment permits only “text” alphanumeric substitutions, but in the generic form input (NDS) modality, any of the form controls (text input control, dropdown list value, and the like) may contribute to the placeholder map. Thus, when the template URL from the webservice requests a placeholder_zip value from the webservice database and rather than ask the user, the zipcode from the database is substituted (unless it is null then a popup window dialog requests the missing data).

Secondary/tertiary placeholders are semi-permanent; the preferred embodiment sometimes uses the term “extended placeholder” when referring to the secondary/tertiary placeholders that are not system placeholders. Extended placeholders are queried and filled when first used, the data may be optionally written into the webservice database. In some cases, a service template associated with a theme may flush old values and replace them or compile a history of previously used values for later reuse. Rather than flushing, add new entries to previously used data for the placeholders. In the preferred embodiment, a given service template may be present in two or more themes. The preferred embodiment preferably creates separate substitution lists for the same service in the different themes, though in some embodiments it may be desirable to provide a universal substitution list for a service used in multiple themes.

A second pseudo-dynamic URL definition modality for the preferred embodiment and an alternate treatment for placeholders denominated as the NDS modality is described as follows: In addition to the www.url.com/?q=<<placeholder>> concept, the current specification of the project includes a second type of pseudo-dynamic URL capture: Desired input fields from a website are identified with placeholders defined as “static” “primary dynamic” or “secondary dynamic” control fields and subsequent operation of the service template reacts appropriately depending upon the state of the tool, the tool inputs, the website.

When a service template includes only static fields, they are filled in with the static data and the website/query is launched. When a service template has only a single primary dynamic field, data from the data input field of the interface is substituted into the appropriate webpage field/control/placeholder and launched (this still holds true for static fields in addition to a single primary dynamic field). When a service template has multiple different primary dynamic fields, a popup window dialog is presented to receive the multiple inputs. Secondary dynamic fields act like primary fields when first actuated, but thereafter the entered valued is stored and the placeholder is thereafter treated as static (until reset). Thus a single secondary dynamic field may be set by the data input field value or a popup window dialog. A primary dynamic field and a secondary dynamic field will initially popup an input control but thereafter the interface operates using the data input field (until reset). Unless mapped to the system data, dynamic secondary placeholders are user and service dependent. Provision is made in the preferred embodiment to label placeholder queries provided through the popup dialog. In some instances, the label may be provided by the tooltip attribute associated with a service control. In other instances, the popup window dialog may include additional prompts for the user. Use of centralized system data permits use of templates without requiring various “cookies” or other local storage/customization methods.

Secondary dynamic may be similar to system placeholders where a user may store standard login/password information. They will thus be “static” when the system placeholder exists and treated as a dynamic placeholder when the data does not exist.

Placeholders in either type of URL (DS/NDS) may include these types of placeholders. The “clear function” enables a user to re-enter secondary dynamic information, and is applied individually at the service level.

With regard to the NDS modality, the primary/secondary/static placeholder implementation concept exists but is typically implemented differently. The first modality (DS) is the direct substitution as we have described. The second modality (NDS) is, in some ways a more generic and flexible solution but in other ways it can be less useful such as when a query dialog is not available or not recognizable by the interface so it is advantageous to offer multiple types of template modality to provide access to a wider range of resources. In this NDS modality, the available data entry controls on a webpage have been identified and pretagged as relevant to a particular service (this is assigned by a person creating the service link (this person is the one having capture rights—which typically leads to service creation), along with which controls received what kind of placeholder input. The service link fills in the pretagged controls with the appropriate data and launches the page with the data as configured. This NDS modality may be more difficult to implement in a completely independent form. In a capture/definition phase for NDS templates in the preferred embodiment, all possible control inputs are identified and one or more controls are identified as placeholders and the placeholders are associated with a static, primary dynamic or secondary dynamic tag, and thereafter launching the template causes those tagged controls to be filled as appropriate for the type of placeholder and the filled query/webpage is launched with the controls of the query/webpage configured by the interface. In this criteria definition phase, the preferred embodiment provides for associating dynamic placeholder status with text input controls of a webpage/query input URL and associating other controls with static status. For example, drop down values, radio buttons, check boxes and the like are defined statically with value(s) appropriate for the service template being defined. Other implementations may provide for dynamic substitution of one or more of these types of controls as well.

In the second modality (NDS), the interface configures controls like text boxes, drop downs, check boxes, radio controls and the like, based upon the URL template associated with that page. This modality, in defining the template, has identified all possible input controls on a webpage and the service creator has selected some set of them as relevant to the current template, with each control of the relevant set a placeholder. The static controls have their value preselected (a value entered for the input controls, a particular one value from the dropdown list, a particular state for the checkbox/radio control, and the like) and the other controls of the set are marked dynamic primary or dynamic secondary. Dynamic secondary may have its value mapped from the webservice database, such as zip code. (Note that in the NDS modality of the preferred embodiment, all controls not included in the relevant set are treated as static placeholders that use the default value (whatever it is—including null).

The interface launches based upon the template with any placeholders filled as appropriate. The template defines the placeholders and the placeholder type and number determine other operation of the tool as to where the placeholders are filled. The services (specifically the public services) are generic for users, with the placeholders/secondary information allowing customization for users (such as <<placeholder-login>>, <<placeholder-zip>>, <<placeholder-password_1>> and the like. Private services/themes may be quite specific to an individual. Each service used by a user has user's own predefined settings (static placeholders values) which a user sets when the interface first launches a particular service and which are stored in the webservice database.

That is, in the preferred embodiment—the placeholders not only are identified in the service template, but the type of placeholder. Also, any particular placeholder may appear multiple times—some templates (particularly the DS templates but a service creator may want to duplicate a placeholder in the NDS template as well) may have <<dp_pholder1>> (dynamic placeholder number one) appear multiple times in the same template. In the case of a single placeholder appearing multiple times, no popup window dialog is necessary.

A specific example: consider http://patft.uspto.gov/netahtml/search-bool.html, a query URL supported by the United States Patent and Trademark Office (USPTO) at www.uspto.gov is shown as query input process 1700 in FIG. 17.

That URL includes a webpage for which a user wants to create the NDS type of URL modality. Assuming that the DS modality does not work or the user wants to use the NDS for some other reason (it is currently believed that for many templates, a DS template may frequently have improved operation over NDS modality templates such as being faster but less robust in response to types of resources and more sensitive to changes in the target webpage/query engine). In the capture/template formation of this example the example query page includes a pair of text input controls (Term1 and Term2) as well as several drop down lists including a pair associated with the text input controls, the user wants the input box associated with Term1 to be dynamic primary placeholder 1 and wants the dropdown associated with Field 1: to be a static placeholder 2 having a value of “Inventor Name”. When those are the only fields in the template, the remaining options on that page are static and are the default value.

Now, when the service associated with this template is to be used selected and “Ponomarova” is entered into the data input field of the interface, the interface may be used to find Ponomarova as the inventors of issued United States patents. When this service is launched, the tool enters “Ponomarova” into the Term1 control on the web page and selects the “Inventor Name” option for Field 1, then launches the query. The interface has thus created a webpage with a list of all Ponomarova patents as that is the result of the query dynamically generated by the interface and applied to the search URL.

In the case that the user desires a more detailed query—the user may produce a more detailed template. For a different template, in addition to the definition above, the user defines Term2 as placeholder3, also associated with dynamic primary but with Field 2 defined as static having a value of “Assignee Name”. When launching this service, because of the rules regarding placeholders, having two dynamic primary fields requires production of a popup window dialog asking for placeholder 1 and placeholder 3. As many users do not recognize how to respond, the placeholders preferably have a label (however, it is also possible to address this in the tooltip text for the service) line Inventor Name and Assignee Name. Entering the data and continuing operation then fills both Term1 and Term2 and launches the query to get all patents invented by placeholder1 and assigned to placeholder 3.

All controls on the page relevant to the desired query are candidates for inclusion in the template. This can get quite complicated but the preferred embodiment simplifies the options by removing some controls from the possibility of being dynamic primary placeholders. As noted above, in the preferred embodiment, only text input controls of a website/query engine may be dynamic (primary or secondary) and the other controls are defined as static for purposes of this template type for second modality.

The use of extended placeholders, particularly in DS modality templates, may be enhanced by providing for placeholder definitions using embedded attributes. For example, in DS modality templates, it is advantageous for multiple dynamic placeholders to include embedded labels so the interface may assist the user when presenting the required popup dialog.

While the addition of new dynamic secondary placeholders (and system data placeholders) is relatively simple when using the centralized storage model of the preferred embodiment, local storage presents additional concerns. Interface 905 of this preferred embodiment includes an ability to dynamically create local variables for previously undefined extended placeholders. In the case that a secondary placeholder is included in a template and the local database does not include the new placeholder, the placeholder is added into the local storage and is treated as an unknown value so the user is queried for an initial value. These placeholders may include additional attributes, such as for example a flag indicating whether the value associated with the new placeholder should be persistent.

Windows Application

In the preferred embodiment, a special stand-alone application is developed to manage the interface at a local computer system. The application maintains all local settings and implements interface-webservice/database cooperation. Much functionality described above in connection of the interface will be actually performed by this application in the preferred embodiment. The toolbar will, in a preferred embodiment, be a simple user interface control and will have limited functions by itself (it will be a user-friendly representation of those functions which will be performed and implemented by the application). However, in some implementations, the application function is incorporated into the interface, or in some implementations the function is integrated into the application/operating system/process itself, such as another application or into the webbrowser.

The application automatically launches at startup and checks connectivity with the webservice server. This mechanism also permits the interface to interact with other applications in addition to (or in lieu of) a webbrowser.

Webservice

In the preferred embodiment, all the user data and account settings are stored at the server in the webservice. The application function loads appropriate data and settings each time it access the webservice.

All users own personal accounts which hold their registration information (like name, login ID, and the like), a list of preferred themes and services, and “Do you want to receive newsletter/marketing” type survey questions. A role for an account determines how many themes are loaded locally and whether a user has creation rights, and local capture rights, among other privilege right-controlled features of the system. In the preferred embodiment, roles include Basic, Standard, Preferred, Professional, Developer, Administrator, and SuperAdmin.

Basic: two themes stored at one time, no write, no local capture; Standard: like basic but five themes; Preferred: like standard but a larger number of themes (e.g., twenty-five) with local capture; Professional: Like Preferred but includes write area into personal area to store own (private) themes for later use—preferably a reasonable but limited number of personal/private themes; Developer: Super Professional—preferably significant space and privileges for private space for private links and themes, with users at this privilege level able to request that certain of their private themes be made public, and these users may create private themes from private and public links, and support theme/link sharing as further discussed below; Administrator: All user abilities including ability to write into public theme area and edit public themes and public service links; and SuperAdmin: like Admin but able to control subscription, user management and service link management for public services. In the preferred embodiment, SuperAdmin does not have a permission to manage private themes or view user configuration/system/ini data. Some implementations may provide additional or different roles or privileges or system resources.

Table I below identifies role options including the options for adding themes and some user management in the user's login space (the specific values may be changed in an admin section of the webservice webserver).

TABLE I
User Roles

| | | | | | Propose | | |
|---|---|---|---|---|---|---|---|
| | Sponsored | Public | Private | Greate | Private | | |
| Level | Themes | Themes | Themes | Public | to Public | Capture | Sysadmin |
| Shareware | 2 | 0 | 0 | 0 | 0 | 0 | 0 |
| Basic | −1 | 5 | 0 | 0 | 0 | 0 | 0 |
| Preferred | −1 | 25 | 0 | 0 | 0 | 1 | 0 |
| Professional | −1 | 25 | 5 | 0 | 0 | 1 | 0 |
| Developer | −1 | −1 | 25 | 0 | 1 | 1 | 0 |
| Admin | −1 | −1 | −1 | 1 | 1 | 1 | 0 |
| SuperAdmin | −1 | −1 | −1 | 1 | 1 | 1 | 1 |

−1; unlimited, 0: disabled, 1: enabled, #: Number of options

Capture is a local ability to create a custom service template. When available and when the user has no private theme space, this template is local use, non-persistent only.

In the preferred embodiment, all users must be at least thirteen years old due to the possibility of storing user data. Age field will be marked as required in the registration, and there will be a special check for its value.

Search Errors

When a browser search error occurs in response to actuation of a service template, the error is flagged at the webservice and associated with the service link (i.e., invalid link flags the associated service link). The preferred embodiment provides an accumulating counter so that the templates creating the most trouble to the users is traced easily. Just a total number of errors associated with a service template, unless the user disables error reporting, is stored in the preferred embodiment (Not the specific number of specific errors though alternate embodiments could record this additional information when useful). Additionally, there is a local option to establish how often the interface rechecks an unreachable service, such as for example to check at every X minutes (e.g., 5 minutes, though a user may desire more frequent or less frequent checking) and the tool periodically rechecks the URL availability. Since this may be a local failure for a specific user and not a failure of the server specified by the URL, the template is not automatically disabled for all users. When the interface determines that the web page is reachable a pop up message notifies the user and launches the previously unusable template.

Theme Management

Public/private themes—Themes may have an ownership attribute set to public, private or system. Public themes may be accessed by all the users, whereas the private themes accessed by the creator of the theme only, or be made available to other users through theme sharing. System themes are special themes and may be made public or private. A point of distinction is that public system themes/service templates may not be copied into user private themes. Public and system themes are created by admin-privileged user accounts. Private themes in general are accessed by the creator of the theme only. In the preferred embodiment, a theme creator may request that a private theme (or service) be made available as a public theme/service (in the preferred embodiment, the request is a message sent to an admin-privileged user or technical support with a description of the theme and its services, some or all of which may be available in the private areas). In this case when the admin/tech support approves the theme (the theme/service is made public), any private pieces are copied and the system is made the owner of the copied elements. Thus, the theme will be available to everyone.

Theme/service sharing is enabled in the preferred embodiment by associating a unique ID to themes and services, and additionally in private areas a theme/service is made shareable by associating a password with the theme/service. Thus, private shared themes/services may be accessed by other users (by providing the unique ID of the theme and the proper associated password) without copying it to the public area. Users may also suggest admin to create a desired theme. In this case they will also send a message containing URL and comment from user.

Theme Creation

Accounts/users with permissions and privileges to create themes may add/edit/remove/disable a theme in their appropriate privilege area anytime. That is, for accounts with private themes only, the associated private themes are manageable by the user. For accounts with public theme creation/editing privileges, the account may manage public, system, and private system themes.

Attributes of a theme of the preferred embodiment include a theme id, name, password (for private theme when making it shareable as blank passwords disable sharing), owner, and service IDs for those services associated with the theme. In the preferred embodiment, a private theme may include public non-protected service links, but not include system service links unless the user role includes system privileges.

Theme creation includes naming, aggregating, and ordering sets of service links. Aggregation refers to identifying which possible MAX_NO of the available services (private, or public, or in the case of SuperAdmin, system services) to include in any given theme. Ordering identifies which service link is associated with which of the MAX_NO dynamic service buttons of the interface when the theme is loaded and selected. In the case of themes including a variable number of services, themes are just ordered and the interface loads a top L themes, L dependent upon user/interface settings.

Disabling a Theme

There is an option associated with each service (and with each theme) to disable the service/theme and disabled themes/services are grayed and unreachable for the interface. Supporting this, an admin includes administrator functions in the webservice that lists (in decreasing number of errors) problem services and includes a control to disable a service/theme for all users. It may be that a service becomes permanently unavailable and the theme/service creator will need to substitute a new service but that is a reason that services may be edited.

Sponsored Themes

In the preferred embodiment, it is possible to denominate a theme as a special theme type—a sponsored theme. A ‘normal’ public, system-owned theme may be marked as sponsored by admin anytime. A sponsored theme becomes available to everyone and a sponsored theme may be added into the theme list by any user role, no matter what number of themes already in use and whatever the role limitation. Sponsored themes will have special considerations for inclusion. It may be unpaid as sample themes/services or special payment outside of the system. To the user, these will appear to be “free.” Initially, the payment will simply be based upon the subscription level. Other special themes may also be provided, such as premium themes that may require special subscription requirements or privilege levels.

In the preferred embodiment, a sponsored service does not exist outside of a sponsored theme. A sponsored theme includes one or more sponsored services. All services in a sponsored theme are available, so it is important that only SuperAdmin class be able to create sponsored themes. A sponsored theme includes any service from the service database, it is up to the theme creator to ensure that the special sponsored services are included in the proper themes. SuperAdmin can mark sponsored themes as system or private so that only the SuperAdmin may add these special services to a theme of any type.

Available Themes

For most users, the webservice lists available themes and permits a user to identify a subset of them for use with the interface, the number and type of themes dependent upon the account role privilege level. Each theme includes a name and a text description to enable a user to decide whether it is to be loaded. (The name and description are managed by admin only, not by users). A user has the ability to tag one theme as the default to be loaded when the interface is launched/activated.

Capture Option

For the direct substitution (DS) modality, a user creates the desired URL in the browser address bar and then “captures it” by providing the information for the service link, as well as telling the system the alphanumeric in the URL that is/are the placeholders.

When the URL in the address bar (at capture time) is http://www.google.com/search?hl=en&q=dog, the user configures the interface so that “dog” is one placeholder, and identifies that this placeholder will be of the static, dynamic primary, or dynamic secondary type.

More complex: The URL in the address bar (again, at capture time) is: http://local.google.com/local?num=100&hl=en&lr=&safe=active&q=dog&near=94920&btnG=Search&sc=l&rl=1, the user identifies “dog” as one placeholder of certain type and 94920 as another placeholder type (which in this case, 94920 is a zip code and also could be available as a system placeholder for launch-time substitution). In the preferred embodiment, the user provides some parsing/creation information such as number of placeholders in the captured URL and other information such as text/symbols in the URL that will be the placeholders.

In the preferred embodiment, a function of the “default” URL is to navigate a user to a search engine or query input site where an input form exists for more easily entering complicated search queries that may not be appropriate to convert into service templates for repeated use.

Capture is available for everyone according to the role table. Those who are permitted to create services will use captured links for this purpose. Those users who cannot create their own themes may use captured links for requesting/recommending a theme/service.

For users with private theme creation, this feature lets them define their private services. Public services will also be available to private theme creators, who can combine public services and their own private services into their private themes. In the preferred embodiment, services may be owned by a public account or by a system account. Services owned by a public account are available for private themes and system owned services are unavailable for private themes.

Interface Supporting Site

The preferred embodiment provides a supporting network site (e.g., website) that provides the following services: Public area:—Login page and general information (Help, comment, FAQ, suggestion (some email addresses), terms of use, privacy, and the standard pages will be accessible from login page. Site administrator are able to edit these pages locally and update using conventional systems such as, for example, an ftp server.); Registration:—An active embedded toolbar to demonstrate the functionality from the website using a default set of themes; User area including Personal information, password recovery, a list of available themes (public, sponsored and shared themes; users may add themes/services to ‘chosen list’ directly at this page); a list of chosen themes with editing ability (add/refuse a theme/service according to role permissions); personal/private themes (when available according to the role's permissions); personal theme editing (add/replace/disable/remove service/theme, change password); creation or modifying a service opens a page with service template where user points service attributes (button label, default and root uris, static/dynamic placeholders, password, tooltips); get shared theme page (2 input fields: theme id, theme password; when ID/password are correct the theme appears in the available list and the user may add it into his ‘chosen list’ provided the user has not exhausted the number of permitted themes); my placeholders values (user chooses a service from the list of his chosen themes and gets all placeholders assigned to this current service and his own values which he had input before; the values may be changed at this page); subscribe to a newsletter; Admin, superadmin areas provide—public themes/services creation, editing, disabling, removing, search engine management (add/remove a Search engine) (SuperAdmin role), theme requests management (admin receives textual messages with links and descriptions; a request form contains button ‘create theme’ which redirects admin at the theme creation page), set role permissions table (manually, in configuration file), manage users (opens user list; each entry leads to this current user's profile; directly at this page admin may change user role or ban the user), neither admin nor superadmin role may modify private themes of users, set pricing policy (admin sets subscription terms and fees), manage triggered services (admin gets error report beginning with the most troublesome services, each entry leads the user at the editing page for the current service (here the user is able to set the service as disabled), mark a theme as sponsored, upgrade private theme to public, and a form for a new newsletter.

Managing Service Links

Provision to create/manage the service templates (including the button labels (some text), root URLS and placeholders (primary, system, and/or temp), default, status, help text, and the like). Password recovery option (user enters an e-mail address (which was used while registering) and gets the password e-mailed there). Locating flagged services (identifies broken links (browser errors which are reported to the service) so they can be fixed/disabled/replaced. The function is available for SuperAdmin role only. Option to disable some themes or services. A disabled theme/service is not operational within the interface for standard users. Disabled themes are “grayed” unselectable and disabled services “grayed” unactuable.

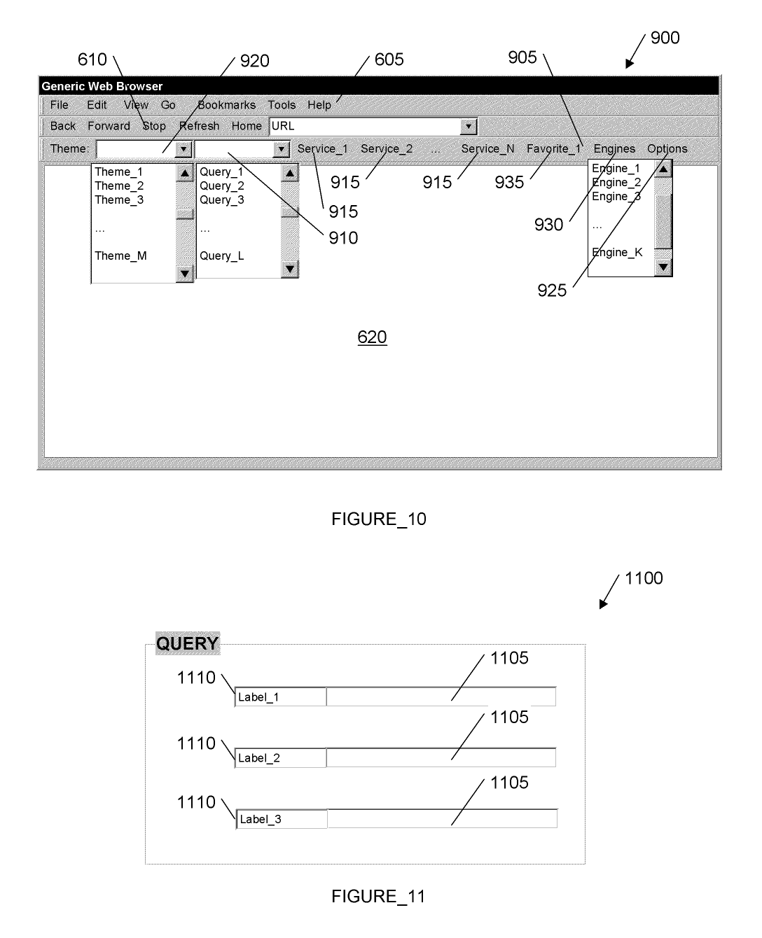

FIG. 10 is an illustration of reconfigured web browser 900 shown in FIG. 9 further depicting operation of data input field 910, theme selector control 920, and engines control 930. These controls include dropdown lists 1000, 1005, and 1010 respectively. Dropdown list 1000 includes a personal history of placeholder substitutions/queries using data input field 910. Dropdown list 1005 includes a list of available themes loaded by the interface from the webservice. Dropdown list 1010 includes search engines (e.g., online or desktop search engines) that are responsive to user options and a current value (new or reselected) in data input field 910 to launch appropriate searching services. Depending upon user configuration options, all or a subset of the available search engines respond to the current contents of data input field 910.

In the case that the selected service template, either associated with a specific service_N actuator control 915 or other control (e.g., favorite control 935 or a search engine of engines control 930) having no more than a single dynamic placeholder, interface control 905 conveniently and efficiently makes appropriate placeholder substitutions using data from data input control 910 and other webservice data (e.g., system data) as necessary. In the case that an activated service template, at the time of activation, requests data for two or more placeholders lacking data (e.g., a combination of two or more dynamic primary and dynamic secondary and ‘null’ system data placeholders) then an additional interface element is used by the preferred embodiment. While FIG. 10 illustrates dropdown extensions for selected controls, other implementations may provide for additional or different controls to be provided with history or extensions. For example, the favorite control may be provided with a dropdown control to permit multiple favorites to be defined and used. The history associated with the text input control, search engine combinations, and other customizations may be stored in the user data of the webservice to enable a user to preserve template substitutions and other operational features of the system. When a history of user may be stored centrally, the preferred embodiment provides for flushing the saved history from the webservice.

FIG. 11 is an illustration of a popup dialog control 1100 used as such an additional interface element to accommodate templates requesting multiple placeholder substitutions. Control 1100 is, in the preferred embodiment, a popup window that identifies missing data for an activated service template and conveniently permits the user to make appropriate entry. A plurality of data entry fields 1105 are presented for collectively receiving the placeholder substitution data, which in the preferred embodiment includes alphanumeric data. Each data entry field 1105 preferably includes an associated label control 1110 as an aid to the user as to the nature of the placeholder data for the associated data entry control. As noted above, this popup control 1100 is implemented in the preferred embodiment largely for text input control substitution values, but other implementations may include other types of controls for user selection. Checkboxes, radio buttons, and dropdown lists are examples of the types of controls that may be included with control 1100 in addition to, or in lieu of, the data entry fields.

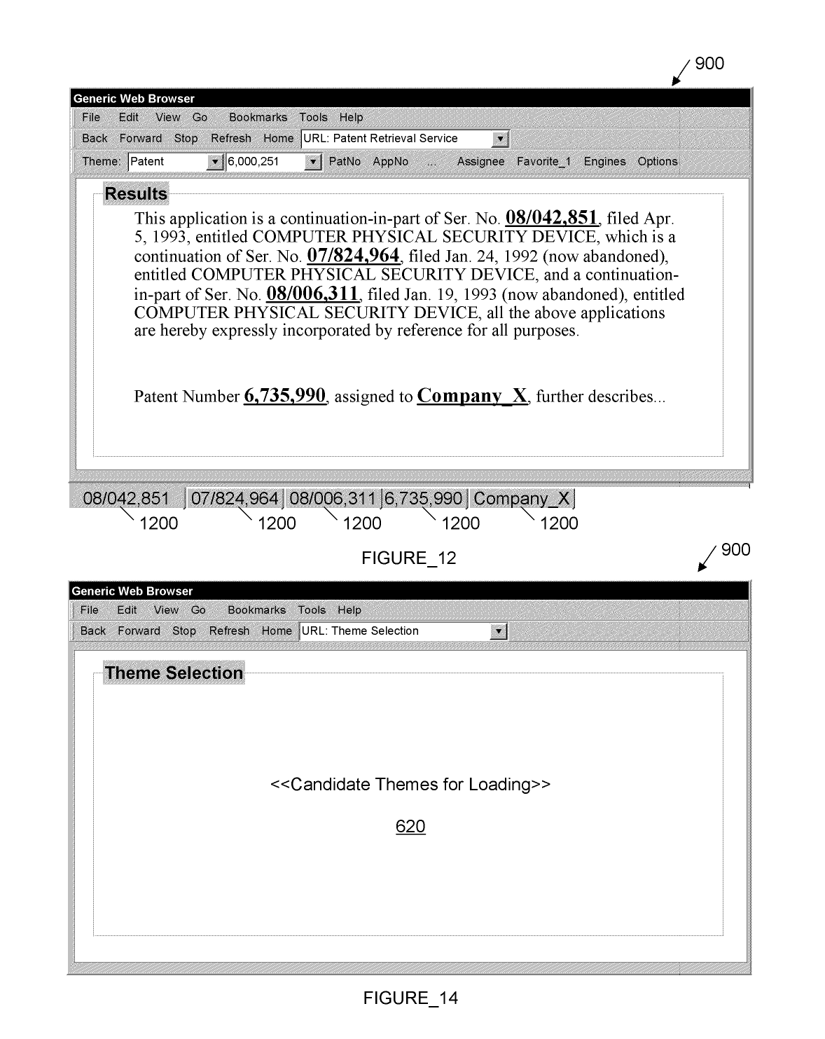

FIG. 12 is an illustration of reconfigured web browser 900 shown in FIG. 9 and FIG. 10 further depicting a specific example of heuristic service activation. Web browser 900 is configured with interface control 905 in which a “patent” theme is selected by theme selector control 920. This patent theme includes a number of “patent” services, including retrieval of a U.S. patent by patent number (the PATNO actuator control), retrieval of a published U.S. patent application by application number (the APPNO actuator control), and retrieval of patent documents by assignee (the ASSIGNEE actuator control). There is a plurality of specific network-based query services that could provide these types of information. For this example, the specific services are not so important other than the availability of each query service is represented by an appropriate service template mapped to the actuator control when the patent theme is selected. Note that this is one advantage of the preferred embodiment, the user is not required to locate and choose among these different services as the interface facilitates the use of an appropriate service for the user automatically.

The subscriber in this example has used interface 905 to retrieve a text-based copy of U.S. Pat. No. 6,000,251 (the subscriber entered “6,000,251” into data input field 910 and operated service actuation control 915 associated with the PATNO service template. As shown, windows contents 620 displays U.S. Pat. No. 6,000,251 (at least partially due to the size of the patent file and the display resolution).

Interface 905 heuristically applies the service templates of the patent theme to the contents of browser 900 automatically (though some embodiments may preferably respond to a manual initiation of this feature) to apply appropriate templates to appropriate elements of the contents. This is made easier by use of the theme concept in that the subscriber has implicitly narrowed the possible context of the contents of the browser by selection of the theme. That is to say, a string of numerals or text may possibly represent many different and varied data constructs in the abstract, but in the context of a “patent” theme, a seven digit number less than seven million may be taken to have a higher probability of representing a patent number rather than a telephone number, for example. A preferred embodiment of the present invention exploits this context-reducing nature of the theme by applying the service templates to candidate elements in the search results. As noted elsewhere, some themes may be provided with context libraries or validation checks and the like to provide heuristic/expert system templates/services.

As shown, U.S. Pat. No. 6,000,251 includes a portion is which additional patents and applications are identified, as well as entity names. By pattern-matching or other heuristic technique, these additional patents and applications and entities are applied to the appropriate service templates (i.e., the PATNO, the APPNO, and the ASSIGNEE service templates respectively) automatically applied and separate browser windows (or tabs in tab-enabled browsers) are launched to display the relevant content. Browser 900 is shown as a tab-enabled browser in which each of the identified patents, applications, and entities (shown highlighted in the contents window) has been prefetched and made available in a separate tab/window 1200.

It is an advantage that, in a broadband context, there is not much downside to this “look ahead” feature to anticipate a subscriber's application. Should the subscriber not want a prefetched window, it is easily closed without adverse effect but when the resource is desired, the interface has saved the user time. The preferred embodiment provides a user setting to specify how “deep” the look ahead feature is applied. That is, from a first query, a decision is made as to which results the look ahead feature is applied. As shown, the heuristics automatically retrieves additional patents, published applications and Assignee information. These “first level” retrieved resources may additionally identify other patent numbers, publication numbers, and entity identifications “second level” that may appropriately have the theme information heuristically applied. Each level may generate another level; the preferred embodiment sets a limit to a depth of automatic application of this feature. An additional setting controls whether heuristics are automatically applied to opened documents when a new theme is selected. When a user changes tasks as possibly reflected in selection of a new theme, it may sometimes be appropriate to apply the service templates of the newly activated theme to the resources in the opened browsers/windows.

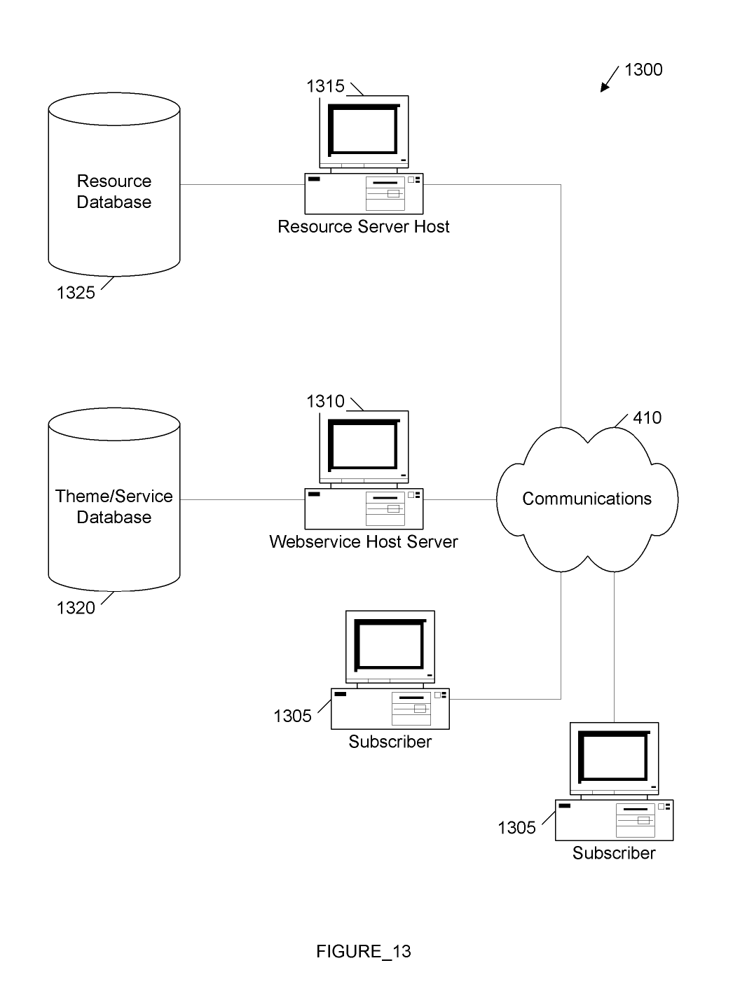

FIG. 13 is a schematic diagram of a network implementation of a preferred embodiment of the present invention for a theme-based resource retrieval system 1300. System 1300 includes a plurality of computing systems, such as specific implementations of those systems shown in FIG. 1 and FIG. 5, with system 1300 being a specific implementation of the system shown in FIG. 5. Computing systems in system 1300 include subscriber stations 1305 and network servers. Subscriber stations 1305 host an implementation of interface 905 to connect to a webservice operating on a webservice server 1310. Interface 905 loads appropriate themes and associated service templates and, responsive to subscriber operation of interfaces 905, retrieves various resources from one or more resource servers 1315. Webservice server 1310 includes an associated theme/service database 1320 and resource server 1315 includes an associated resource database.

FIG. 14 is an illustration of a modified browser window 900 depicting a theme selection window. Windows content 620 in this configuration includes a list of candidate themes on theme/service database 1320 available to the subscriber based upon role and other account settings. A selection mechanism enables the subscriber to select an appropriate number of themes and to select one theme as the default to be active when the themes are loaded by the interface operated by the subscriber. The interface, in the preferred embodiment, logs into the webservice using the subscriber credentials; which then loads the identified themes and associated service templates. This is done directly or through use of the supporting application.

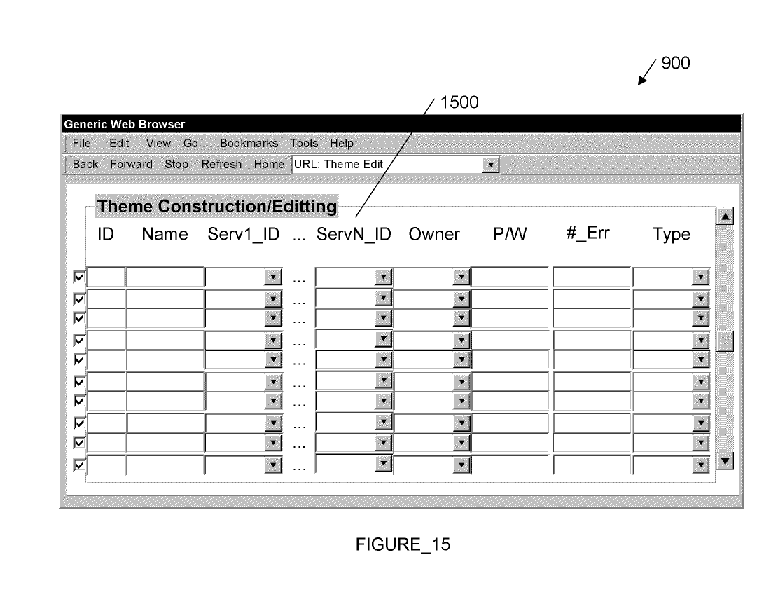

FIG. 15 is an illustration of a modified browser window 900 depicting a preferred theme creation/editing interface 1500. Interface 1500 provides a mechanism to create and edit themes for use with interface 900. Each theme includes a number of attributes, some or all of which may be appropriate for editing. These attributes include, in the preferred embodiment, a theme ID, a theme name, an ordered and aggregated identification of associated service templates, an owner, an optional password, an error accumulator, a type attribute and an active/inactive checkbox control.

The theme ID uniquely identifies each theme in theme database 1320. The theme name is the user-friendly label associated with a theme that appears in the theme selector control when the theme is loaded into interface 900. Database 1320 stores a plurality of preconfigured service templates, also having a set of attributes. These attributes include a unique service ID and other attributes as identified above. Each template selection control of any specific theme permits the creator/editor to associate one of these preconfigured service templates with such specific theme, consistent with user/account role/privilege level. The owner field identifies the associated owner type which influences various operational features as disclosed herein. In the preferred embodiment, these owner types include private, public, and system owners. The optional password permits sharing of private themes—entering a password enables sharing of the associated theme, and any subscriber thereafter has the ability to add a private theme for loading into the subscribers interface 900 by providing the theme ID and proper associated password. The error accumulator is a counter that identifies how many times the templates of the associated theme have been involved in a browser navigation error (e.g., a bad link, an unrecognized command, and the like). This feature is also available with each service template to recognize potentially problematic links by accumulating navigation errors with each service template. The type attribute may specify themes that are treated differently by the webservice and/or subscriber interface 900. For example, some themes may be identified as normal, sponsored, or premium, and the theme selection interface shown in FIG. 14 responds appropriately based upon subscriber role/privilege level. The active/inactive control permits easy deactivation of a theme should problems develop that warrant removing it from subscriber interfaces. Different theme creators may have different options or limited subsets of options available depending upon their role/privilege level.

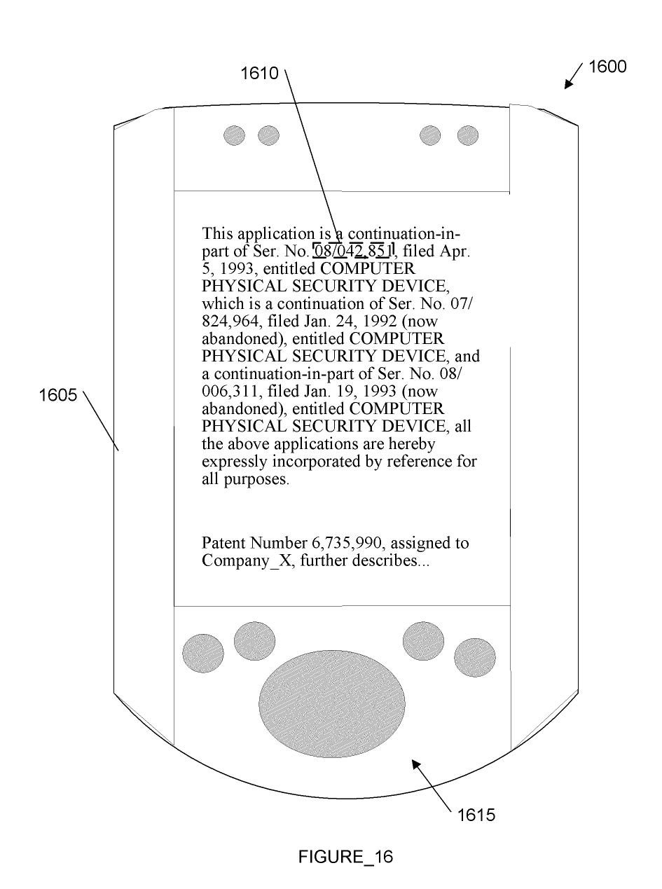

FIG. 16 is an illustration of implementation of an alternate interface 1600 for a preferred embodiment of the present invention using an alternate computing system such as a portable electronic device 1605 including cellular phones, personal digital assistants (PDAs) and other wireless devices including browsing/resource access-retrieval capability. Interface 1600 is designed to facilitate subscriber input by generating a selection cursor 1610 (e.g., shown as dashed line for legibility) that highlights one or more text elements of a content of a web browser of device 1605. Device 1605 typically has limited interface controls 1615—cellular phones include a numeric keypad with a limited set of additional controls to facilitate operation of the telephone and other features (in such a case, the additional controls manipulate cursor 1610 and the numeric keys select a particular one service template, for example). Similarly, PDAs typically include fewer controls (particularly for those stylus-based PDAs) while other PDAs may include limited keyboards. Interface 1600 provides a mechanism in which these limited controls may be implemented to achieve at least some of the advantages of interface 905 implemented on a desktop computing system.

In these generally limited input systems, interface 1600 permits a simple and efficient mechanism to enable a subscriber to achieve at least some of the advantages of the present invention. In operation of a preferred embodiment, the limited controls of device 1605 operate to achieve three functions: 1) moving selection cursor 1610 between and among the text elements of device 1605 browser contents; 2) expanding/contracting selection cursor 1610 to highlight more or fewer contiguous text elements; and 3) activating a particular service template using the contiguous text elements identified by selection cursor 1610. In the limited interface and resource capacity of many devices 1605, the number of themes, number of services/theme, number of attributes of the themes and services may be reduced. In some cases, a user may not be able to select more than a few (sometimes a single) theme. The limited controls and display may require adjustment of some of the features but a preferred embodiment provides acceptable use in these limited environments. A subscriber identifies a set of service templates having one or more templates, operates selection cursor to identify desired text elements and then activates a particular one service template with the identified text element(s) displayed in the browser window.

In some embodiments, the substitution history of data input control 910 may be conveniently stored in the webservice, as well as, optionally, a service template use history, and/or a history of which substitutions were made for which templates. These histories may not only be used by a subscriber, but also by the webservice in providing relevant additional resources or other services for the subscribers based upon or derived from these histories and associations. These additional resources may be presented in additional windows or embedded content in the provided resources (e.g., contextual targeted advertising or other contextual targeted content). In the preferred embodiment, each time a user (or the interface) launches a new browsing window (independent window or tabbed window), the substitution history of the launching window may be replicated (as specified by configuration parameters) in the new window or windows.

The configuration of the present interface offers website administrators a quick and convenient mechanism for providing toolbar functionality for their website or websites. Rather than developing an independent toolbar to be added into a browser along with independent toolbars from other independent websites, many functions of a website may be conveniently provided to potential users by defining a theme and services specific to the website. Administrators in this way save costs and increase convenience of users without adding “yet another toolbar” into browsers.

Advertising and marketing campaigns are closely related to Internet functionality, some of which have been discussed above. The preferred embodiments of the present invention enable yet another advertising paradigm. The development of the theme/service based Internet Navigation that conveniently encompasses virtually any site and many Internet-related tasks, particularly location and retrieval tasks, the interface enables many enhanced features for users and administrators desiring to implement these features. For example, one preferred embodiment of the present includes implementing a rewards-based system for using the interface (which also means accessing various sites and services as specified by particular service templates). This preferred embodiment monitors access and use by a user and rewards a user for use of the interface to access sites and services. In one implementation, each time a user access a site using a service template, the user has a chance (determined randomly) of being rewarded with a prize of some sort, which may be specific to the service template actuated. This is possible because of the dynamic and pseudo-dynamic URLs generated by the interface, so it may include user information. For example, users accessing website “X” using the interface may receive some prize (e.g., gift certificate, product, or service or the like from the website, from, for example, an advertiser of the website, from an advertiser of the interface provider, or from the interface provider. Different odds may be assigned to different classes of products or promotional items, so that low denomination/low value prize is awarded more frequently than a greater denomination/value prize as well-known. By providing a centralized Internet browsing/navigating system and method, it is easier to implement this type of solution. It is also possible for administrators of websites to participate in a pooled prize/reward system which saves them the resources (e.g., time and money) to implement and manage such systems on their own. Rather than simply awarding randomly determined prizes, the interface of another implementation may award prizes based upon “points” provided for certain activities, like visiting particular websites or actuating certain templates. Some of the preferred embodiments contemplate a subscription-based system having different membership levels—in such cases the different levels may use a different multipliers to any points awarded for different tasks.

Additionally, the desktop application component, cooperating with the interface, may report interface user operations for prizes, points, or browsing history tracking when so configured and authorized by the user. The desktop application may also access real time data feeds, including advertising, based upon a selected theme or particular templates that are activated. The content or stream (e.g., particular advertisement or promotion) selected in response to a theme or service template actuation may be predetermined at the theme server or dynamically determined by the desktop application component.

In addition to the features and functions of the preferred embodiments described above, the present invention encompasses further features and functions enabled and/or facilitated by the preferred embodiments. Some of these further features and functions include use of a modified version of interface 900 to control and limit resource access, such as for child controlled or content controlled resource acquisition. Interface 905 is configured to be the only input system for a resource access application, like a webbrowser for example. Thereafter, suitably providing appropriate service templates and validation/qualification libraries to limit the type of data substituted into placeholders provides resource safeguards, including protection for children.

While the preferred embodiments have been described in connection with remote webservices (including a webservice server and theme/service template database) for storing and accessing themes and associated service templates, themes and services may be distributed or made available to a user in another mechanism. In an alternate preferred embodiment, a webpage or other network site or location includes embedded code that is recognized by interface 905 as a theme with associated service templates or as one or more service templates. The embedded code may include meta-information that directly defines themes and associated service templates, or that indirectly defines a theme. Direct definition includes theme attribute definitions for name and associated attributes of the associated service templates. These definitions may be recognized and directly loaded by interface 905 when accessing such a website to be available in cooperation with the site, or the embedded-code may include identification information to look-up appropriate data for theme and/or service template attributes. In this embodiment, when a user accesses such a web resource, interface 905 is customized by the web resource designer to provide access/functions while at the site. Some of these access/functions may not be otherwise available to the user when at another site. Interface 905 of this preferred embodiment may include user options to make the theme and/or services persistent, such as by storing the attributes in the webservice database for the user (e.g., as a private theme when private theme creation is allowed). In other instances, it may be permitted to authorize a subscriber to copy an embedded theme/service link to the favorite control or otherwise capture one of these services to a subscribers private service webservice database. Not only private themes, but also sponsored themes or other theme types may be defined and made available to a subscriber through this mechanism.

The preferred embodiments described herein typically include service templates having one or more placeholders. While the above description describes, and interface 905 supports, static service templates, much of the discussion includes dynamic service templates (e.g., service templates including one or more dynamic placeholders). Alternate preferred embodiments of the present invention include a capacity and function for managing and using locally defined “favorites” (i.e., static links). Conventional webbrowsers provide an ability for a user to define locally a static URL as a “favorite” and in some cases to arrange these favorites into a hierarchical folder structure for organization and use. This conventional structure is improved in the preferred embodiment by treating these favorites as static service templates and organizing them into favorite themes; particularly when this favorite structure is stored in a webservice (such as remote theme/service template database) for use of the same favorites across multiple platforms and computing systems. An aspect of the preferred embodiment of the present invention provides for conversion of local favorites into static service templates, organized when appropriate into themes defined by a favorite folder name, and optionally upload into a user's private area so the favorites are available across all the computing systems of the user.

The form and function of the preferred embodiments of the present invention described herein also suggest that resources may be adapted and developed for synergistic cooperation with interface 905. For example, some resources may have streamlined access via interface 905 as complicated URLs may be used since a subscriber no longer need remember them. These complicated URLs may include audit, account, affiliate, login and other types of information to ensure that use of the URLs is appropriate and consistent with agreed upon terms. In addition to simplified identification, access, and retrieval of resources using specially customized URLs (such as a special interface-only-enabled query engine page (e.g., all controls on such a special page could be invisible or otherwise inaccessible directly by a user not employing interface 905)) it is possible to produce results customized to interface 905 access, as well as use of user information (registration/webservice data) in cooperation with template access to produce targeted response and other content (e.g., advertisements) in addition to the query response.

The preferred embodiments of the present invention provide a mechanism to not only identify and retrieve resources based upon customized and dynamic real-time queries launched using predefined service templates, but to also facilitate further processing of such resources. There are webresources that not only produce an output in response to a query, but there are other types of resources that receive and process/transform a resource of one type into a resource of another type. The embodiments of the present invention may be used to produce customized resource(s) and resource(s) list(s) that are used as inputs into these processing/transformation webresources. For example, it is possible to configure interface 905 and its themes and associated service templates to retrieve a particular resource, such as a document in PDF (portable data format). There are local PDF viewers that permit the subscriber to view locally the document retrieved onto the local computing system. Alternate preferred embodiments of the present invention provide for launching the processing/transforming webresources from interface 905 to interact with resources identified by interface 905. One way that this is possible is to use the resource URL (available in the address control of the navigation bar for example) as an input into another service template of interface 905. This feature, combined with a desktop search engine, such as available from Google Desktop Search, in which local resources of a local computing system are available using a service template, for example in DS modality by identifying the desktop search engine, permits service templates to access and use and process local resources in addition to remote resources, and in appropriate cases combine local and remote processes into various service templates. Thus local resources may be processed and accessed using templates, and local resources may be processed/parsed with one set of templates with results applied to the service templates or to another set of templates. In this way local and remote resources may be both made available the user. For example, a template may use a service template to use the desktop search engine to locate a local resource. A service template may parse the URL to determine attributes of the local resource, such as a file name and file location. Then a service template may use a template to with other resources (local and remote) in cooperation with the parsed data to provide additional user functionality. For example, one of the other access protocols may be used to upload the local resource using FTP as configured using a service template. This is but one example of the types of interactions possible when combining local resources and desktop search engine in combination with themes, templates, remote resources, and other local resources, particularly using the macro/scripting service/theme chains/combinations described herein.

In the preferred embodiments of the present invention described herein, subscribers are generally authorized to include a limited number of themes at one time from the webservice, the particular number varying by role and privilege level. As an organizational aid to the users, no matter their role/privilege level, but potentially particularly more valuable to subscribers having fewer available themes at one time, a preferred embodiment of the present invention implements a concept referred to herein as meta-themes. In this concept, another hierarchy level is introduced in which a user may define one or more meta-themes, each meta-theme including a set of identified and available themes. Rather than identifying and loading individual themes into interface 905, a user may choose a meta-theme for wholesale replacement of the currently loaded set with the newly identified set of themes. For example, in a case where a subscriber is limited to five themes at one time, a user could define sets of meta-themes, each meta-theme having up to five themes. A user may define a meta-theme as an IP meta theme that includes a patent prosecution theme, an International prosecution theme, a trademark theme, a patent legal resource theme, and a technology search theme. Additionally, the user may define a second meta-theme as an Entertainment meta-theme that includes a movie theme, a music theme, a DVD theme, a theater theme, and a current events theme. The user may thus easily reconfigure interface 905 by selecting between the meta-themes rather than individually selecting and deselecting the desired themes.

Further to enhancing user ease of use, a preferred embodiment of the present invention provides for multiple entities to be associated with the webservice. The multiple identities include two aspects: 1) facilitating multiple users from one account, such as a parent setting up an identify for use and also setting up an identity for a dependent child; and/or 2) facilitating multiple sets of system data for a particular user, such as a user setting up a work persona and a play persona. In the first aspect, changing identities may be used to set/reset various controls and theme options (e.g., when the child user signs in, interface 905 reconfigures itself for the themes of the child). In the second aspect, changing a persona permits an alternate set of system/secondary data to be used with the service templates, as well as possibly reconfiguring the theme sets.

In alternate preferred embodiments of the present invention, it is a further enhancement to user interaction and use of interface 905 to provide for chaining or combinations of themes and or service templates of a theme. For example, it is sometimes the case that the resource identified as a result of one service template may be used as an input into another service template. Successively linking an output of one service template to an input into another service template is an example of chaining. In addition to service templates being chained, themes may be chained, particularly for macro/script themes as described below. It is also possible to form combinations of themes and service templates by applying them in parallel, such as activating all service templates of a theme responsive to a single input value for the data input field. Other embodiments includes collections of successive chains and parallel combinations in what may result in quite complex resource processing. Particularly when heuristics and recursion are applied, interface 905 operates to produce a complex processing pattern for resources as customized by the user and user input.

An aspect of the preferred embodiment includes generation of resources in a format for use with an implementation of interface 905. For example, it is the case that some resources define a collection of elements and it is sometimes desirable to access individual ones of the collection using a service template. A document resource in PDF (portable data format) that contains a group of related elements, like for example, sections of the Manual of Patent Examining Procedure (MPEP) or Code of Federal Regulations (CFR) or United States Code (USC). It is common for whole sections of a chapter of the MPEP, or an entire title of the CFR or USC to be included in one PDF document. It is also sometimes desirable to access a particular section from the chapter or portion of a title and an ordinary PDF resource may not permit desirable access using service templates. Therefore, one aspect of the preferred embodiment includes creating a new resource (e.g., derived from another resource or original) having certain elements accessible using service template. For example, a PDF of an MPEP chapter (e.g., Chapter 8) is converted into an HTML (hyper-text markup language) resource recognizable by webbrowser resource access applications and other computing system processes. The specific sections of Chapter 8 are identified by HTML code (e.g., bookmarks) that permit a webbrowser to open a specific section of an HTML page. A service template that accesses the Chapter 8 HTML code and that uses the bookmark as a dynamic placeholder permits interface 905 to respond to a Chapter 8 Section query by opening the HTML code to the specific bookmark. For a NDS modality resource, a query engine is provided that searches on section numbers and that has properly indexed a query-engine compatible version of the Chapter 8 contents. It is also the case that some PDF resources include certain bookmarks, so generation of a service template compatible version may include HTML compatible bookmarks at the appropriate location marking the PDF bookmarks, then using interface 905 to access and retrieve these sections. Other indicia from a resource (page number, chapter headings or other features or content of the resource) particularly those that may be identified and converted using automatic processes of a computing system may be used. After a resource is converted to a service template compatible resource, a service template may be defined and added to a theme as described herein to access and retrieve the specified elements.

Additional preferred embodiments include providing an additional level of automation, providing for macro scripting or other automation activities. In addition to the chaining and combination features described herein, additional logic and programmatic control elements (e.g., variables, mathematic functions, decision logic, branching/loop control and the like) are combined with service templates and themes for further processing of resources and user data/input. These automation aspects of the present invention provide for a number of features, including processing of multiple resources using a service template or set of service templates. One particular example of this preferred embodiment is automation of account creation service templates using user system data. A new user completes the user data section (also sometimes referred to herein as system data) that may include a preferred standard user login ID and user password. The user selects themes and/or service templates for desired account setup (these may be individual setup scripts for a single account or for creation of a set of accounts). These may be actuated from the interface or the webservice may launch certain service templates on behalf of the user without further direction or interaction from the user, or in some instances the webservice/interface may acknowledge that the account(s) have been setup or it may query the user in the event that the desired account ID is unavailable to request an alternative. It is the case that complex account IDs may be used with the system as the service templates will assist the user in logging in and accessing account-specific resources. In this aspect, a single complex arbitrary login may be used across all accounts to facilitate use with interface 905.

As a more specific example, a theme includes service template macros/scripts for creation of accounts with AOL, MSN, and YAHOO. A user desiring new accounts at these service providers chooses this theme and webservice/interface creates new accounts using the secondary data when possible. When the secondary data does not include acceptable information (the login ID is unavailable for example) webservice/service template automatically uses an appropriate ID or queries the user). It is possible to use random character generation for the ID/password and use the generated ID information for all new accounts to increase a chance that the ID will be consistent across accounts when that is a user goal.

This preferred embodiment is useful for new users unfamiliar with the wide range of accounts and services available, as well as providing a user with quick access to resources/services that they have not previously heard of or not specifically enrolled. User options include auto-account creation when a service template attempts to access a resource requiring account creation. In some instances, account creation may require use of billing/payment information so the user may provide credit card information in the system data (either in persistent or non-persistent format) or respond to popup dialog windows to facilitate this aspect of the present invention.

In a preferred embodiment of the present invention, interface 905 responds to hotkey assignments as described herein. Additionally or in lieu of these hotkeys, other interface options are provided to integrate contents of a retrieved access back into the service templates. For example, a user may position a cursor of a computing system supporting an aspect of the present invention onto an element of the resource (a word, phrase, picture, embedded object and the like) and activate an interface option to direct that element to the desired service template(s), script(s), macro(s), theme(s) or the like. For example, a user may position the cursor over a word in the contents window and right-click a cursor positioning system (e.g., using a button on a mouse) while over the word to present a “right click menu” that presents interface/theme/service template options for further processing of the word. Other resource elements/contents may be similarly treated.

Another aspect of the preferred embodiment of the present invention includes modification to search engine input and query engine input pages and controls. Currently it is the case that input controls on a search engine input page or on other input query page have differing names, and in some cases the variables are not named in a manner that suggests the type of data intended to be received by the variable or associated control. For example, sometimes a webpage having a single input control will label (internally not for user consumption) the control as “q” or the like. This variable labeling is not always consistent across a single set of webpages at the same domain. There is no standard for labeling these controls, so there is no consistent labeling across domains, and until this aspect of the preferred embodiment of the present invention there was not much reason to have consistent control labeling. This aspect of the preferred embodiment includes two independent features: 1) providing for standardized consistent control labeling to facilitate automation or other use between interface 905 and a search/query input engine; and 2) facilitating automation or other use between interface 905 and a search/query input engine by substitution of appropriate user data into recognized controls.

In the first feature, a search engine/query input page may label a field that accepts a zip code as “zip” or “zipcode” and interface 905 upon actuation of a NDS modality service template and recognizing a control labeled “zipcode” would automatically substitute user data into the appropriate control. Similarly, a main input control could be standardized to be “query” or, taking the preferred embodiments into account, such a control may be labeled “dynamic_primary_query” or “dynamic_primary_query_1” or the like to identify its placeholder role in cooperation with a suitable template. Additional standardized controls are possible, for example name, address1, city, state, country, and the like. In this feature, establishing a standardized set of control labels and facilitating interface/engine interaction is an important goal. In at least one respect, this simplifies template/mapping creation and integrates template features into website definition/HTML pages.

In the second feature, it is advantageous that interface 905 and or a specific service template recognize and map certain control variables to certain types of data for certain webresources and engines. For example, a certain domain may consistently use a variable label “z” for zipcode permitting service templates/interface 905 to prefill a “z” labeled control with zipcode data when appropriately mapped. A user option enables/disables these features; and these features may be available not just upon certain actuations of appropriate service templates, but also during normal browsing activities. That is, just loading a page with recognized controls loads the system data into the appropriate controls.

A preferred embodiment of the present invention provides for appending (either prepending or post-pending) information onto placeholder substitution data. Some search/query engines are permitting a user to enter directives along with a query to provide additional functionality from the engine. An example is that Google permits a user to enter “Books About” plus a query to create a list of books that contain the query. In some cases, the directive propagates into the URL line so direct substitution of a placeholder into a specific and appropriate rootURL of a service template will function properly. However, it may not always be the case that such directives propagate into a URL for substitution so it is desirable to provide this feature in a NDS modality. In some cases, a user may recognize that the directive is available and include the proper directive into the data input field along with the query. However, it is an aspect of the present invention to ease a burden on users and not require that they learn and memorize such directives, as there can be many of them, some may be infrequently used at best. Thus, this aspect of the present invention permits a service template creator to cause a template to prepend a “books about” directive to placeholders submitted to the GOOGLE Books About service template, letting the user enter only the subject into the data input field.

Another use for this feature is to help a user with specific targeted searches/queries. It is the case that at times, a user begins to generate a narrow and specific set of query input terms, sometimes this search/query is repeated by varying a single one of the terms. It is a feature of a preferred embodiment to include an ability to specify such a standard set of search terms that are combined with the data input field query value to aid the user in presenting these specific searches and queries. In appropriate cases, this aspect is available for both DS and NDS modalities.

Many of the preferred embodiments of the present invention are described as a network enabled system in which a webservice stores and facilitates interface interaction for defining and retrieving appropriate service templates for the user. As described, some features and data storage may be localized. It is also a preferred embodiment of the present invention to provide a local-only version of some of the preferred embodiments as appropriate. In these implementations, the template/service template/system and user data storage are local, as is theme and service template creation. The user loses some flexibility in having the themes/templates/data/history stored remotely for uniform access across multiple computing platforms. Additional advantages of fixing broken templates and discovery of new resources may be made available by providing a network accessible system for identifying and downloading themes/service templates, and notification to a user that a downloaded theme/service template has been modified or improved. A user may elect to subscribe to a webservice for access to these themes/service templates, or may acquire themes/services on an individual basis. One specific implementation includes provision of the interface, application, webservice, and site management on a private network for access to private resources on an intranet.

As should be clear, the present invention is not limited to any particular operating system, CPU-type, resource access application (e.g., a specific browser-type) or type or types of resources accessed or retrieved. The preferred embodiments of the present invention may be implemented/adapted for many different platforms, operating systems, computing systems, interfaces, resource access applications and the like without departing from the spirit and teachings of the present invention.

In some of these implementations, interface 905 may be integrated into an application, process, operating system and transparent to the user as it is available indirectly by the type of resource and elements in the resource. In other implementations, interface 905 may be transitioned between transparent and explicit operation, or selected features may be exposed or concealed from a user or operator.

Although many of the embodiments of the present invention have been described primarily with respect to a initiating searches using queries to search/server applets implemented using familiar URLs for identifiers, many types of resource retrieval (e.g., targeted document retrieval, and the like) may benefit from features of the invention. Other query/resource access products such as those contemplated for semantic web identifier access, and the like, may similarly benefit from features of the invention. Not only is the described invention useful to a consumer of search engine results that greatly simplifies the access and retrieval of information indexed by a search engine (e.g., Google, Yahoo, AltaVista, MSN, etc.) but search engines may apply themes to search results presented to a user to provide not only the requested links, but also thematic results for each linked result. To maintain the patent theme described elsewhere herein, when a user searches for information on “Future_Tech, Inc.” if the user requests the patent theme then each search result for “Future_Tech, Inc.” would identify thematic elements in each search results link. A user may then easily obtain patent themed services from the search results. Again, other themes will identify/enable other elements in the search results link.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An apparatus for generating a resource access specification for a network resource, the apparatus comprising:
an interface for receiving a user input and a user selection signal and for concurrently supporting a set of service templates; and
a specification compiling system communicable to a network supporting the network resource for combining said user input with a user-specified service template selected from said set of service templates responsive to said user selection signal to produce the resource access specification.

2. The apparatus of claim 1 wherein said interface concurrently supports a plurality of sets of service templates with said interface responsive to a theme selector to activate a particular set of service templates.

3. The apparatus of claim 1 wherein the resource access specification is a URL.

4. A resource access method, the method comprising:
a) activating a set of service templates;
b) responding to a signal from a user to compile a resource access specification using at least one of said service templates and any user identified placeholder substitutions; and
c) accessing the resource using said resource access specification.

5. A computer program product comprising a computer readable medium carrying program instructions for accessing a resource when executed using a computing system, the executed program instructions executing a method, the method comprising:
a) activating a set of service templates;
b) responding to a signal from a user to compile a resource access specification using at least one of said service templates and any user identified placeholder substitutions; and
c) accessing the resource using said resource access specification.
